(19) United States
(12) Patent Application Publication
(10) Pub. No.: US 2016/0188279 A1
(43) Pub. Date: Jun. 30, 2016

(54) MODE-SWITCH PROTOCOL AND MECHANISM FOR HYBRID WIRELESS DISPLAY SYSTEM WITH SCREENCASTING AND NATIVE GRAPHICS THROWING

(71) Applicant: INTEL CORPORATION, SANTA CLARA, CA (US)

(72) Inventors: Krishnan Rajamani, San Diego, CA (US); Matthew J. Adiletta, Bolton, MA (US); Michael F. Fallon, Tiverton, RI (US); Karthik Veeramani, Hillsboro, OR (US); Ujwal Paidipathi, Beaverton, OR (US); Chengda Yang, Auburndale, MA (US); Amit Kumar, Marlborough, MA (US)

(73) Assignee: INTEL CORPORATION, SANTA CLARA, CA (US)

(21) Appl. No.: 14/583,614

(22) Filed: Dec. 27, 2014

(51) Int. Cl. G06F 3/14; H04W 76/02; G06T 1/00

(52) U.S. Cl. CPC G06F 3/1454; G06T 1/00; H04W 76/023; G09G 2370/16

(57) ABSTRACT

Methods and apparatus for implementing a mode-switch protocol and mechanism for hybrid wireless display system with screencasting and native graphics throwing. Under a Mircast implementation, A Wi-Fi Direct (WFD) link is established between WFD source and sink devices, with the WFD source device configured to operate as a Miracast source that streams Miracast content to a Miracast sink that is configured to operate on the WFD sink device using a Miracast mode. The WFD source and sink devices are respectively configured as a native graphics thrower and catcher and support operation in a native graphics throwing mode, wherein the WFD source devices throw at least one of native graphics commands and native graphics content to the WFD sink device. In response to detection that Miracast content has been selected to be played on the WFD source device, the operating mode is switched to the Miracast mode. The mode may also be automatically or selectively switched back to the native graphics throwing mode. The techniques may also be applied to methods and apparatus that support other types of screencasting techniques and both wireless and wired links.

### BACKGROUND INFORMATION

In recent years, the popularity of smartphones and tablets has soared, with many users having multiple devices and families typically having a number of devices. At the same time, other classes of connected devices, such as smart HDTVs (and UHDTVs) have become increasingly popular, with manufacturers pushing the envelope on performance and functionality. This has led to the development of screen mirroring (also referred as screencasting) and related technologies under which the display content on the screen of a smartphone or tablet is mirrored to another device, such as a smart HDTV.

Several competing technologies have emerged including both standardized and proprietary schemes. One early approach supported by smartphones from the likes of Samsung and HTC was MDL (Media high-definition Link), which includes an MDL adaptor that connects on one end with a standard connector on a smartphone (or tablets), such as a micro-USB port, and includes an HDMI interface to connect to an HDTV. Essentially, the Samsung and HTC phones include a graphics chip that is configured to generate HDMI signals that are output via the micro-USB port, converted and amplified via the MDL adaptor, and sent over an HDMI cable to the HDTV. MDL offers fairly good performance, but has one major drawback—it requires a wired connection. This makes it rather inconvenient and cumbersome.

Another approach is DLNA (Digital Living Network Alliance). The DLNA specifications define standardized interfaces to support interoperability between digital media servers and digital media players, and was primarily designed for streaming media between servers such as personal computers and network attached storage (NAS) devices and TVs, stereos and home theaters, wireless monitors and game consoles. While DLNA was not originally targeted for screen mirroring (since devices such as smartphones and tablets with high-resolution screens did not exist in 2003 when DLNA was founded by Sony), there have been some DLNA implements used to support screen mirroring (leveraging the streaming media aspect defined by the DLNA specifications). For example, HTC went on to extend the MDL concept by providing a wireless versions called the HTC Media Link HD, which required a wireless dongle at the media player end that provided an HDMI output that was used as an input to an HDTV. At a cost of $90, the HTC Media Link HD quickly faded to oblivion.

Another device that combines DLNA with screen mirroring is Apple's Airplay, which when combined with an Apple TV device enables the display content on an iPhone or iPad to be mirrored to an HDTV connected to the Apple TV device. As with the HTC Media Link HD, this requires a costly external device. However, unlike the HTC Medik Link HD, Apple TV also supports a number of other features, such as the ability to playback streamed media content received from content providers such as Netflix and Hulu. One notable drawback with Airplay is video content cannot be displayed simultaneously on the iPhone or iPad screen and the remote display connected to Apple TV.

The mobile market's response to the deficiencies in the aforementioned products is Miracast. Miracast is a peer-to-peer wireless screencasting standard that uses Wi-Fi Direct, which supports a direct IEEE 802.11 (aka Wi-Fi) peer-to-peer link between the screencasting device (the device transmitting the display content) and the receiving device (typically a smart HDTV or Blu-ray player). (It is noted the Wi-Fi Direct links may also be implemented over a Wireless Local Area Network (WLAN).) Android devices have supported Wi-Fi Direct since Android 4.0, and Miracast support was added in Android 4.2. In addition, many of today's Smart HDTVs support Miracast, such as HDTVs made by Samsung, LG, Panasonic, Sharp, Toshiba, and others. Miracast is also being used for in-vehicle devices, such as in products manufactured by Pioneer.

Miracast is sometimes described as “effectively a wireless HDMI cable,” but this is a bit of a misnomer, as Miracast does not wirelessly transmit HDMI signals. Rather, frames of display content on the screencasting device (the Miracast “source”) are captured from the frame buffer and encoded into streaming content in real-time using the standardized H.264 codec and transmitted over the Wi-Fi direct link to the playback device (the Miracast “sink”). The Miracast stream may further implement an optional digital rights management (DRM) layer that emulates the DRM provisions for the HDMI system. The Miracast sink receives the H.264 encoded stream, decodes and decompresses it in real-time, and then generates corresponding frames of content in a similar manner to how it processes any H.264 streaming content. Since many of the previous model smart HDTVs already supported playback of streaming content received over a Wi-Fi network, it was fairly easy to add Miracast support to subsequent models. Today, HDTVs and other devices with Miracast are widely available.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a wireless display system implemented using Miracast;

FIG. 2 is a diagram illustrating the stacks implemented by a Miracast source and sink, as defined by the Miracast standard;

FIG. 3 is a block diagram illustrating a reference model for session management of a WDF Direct Source and WDF Sink, as defined by the Wi-Fi Direct standard;

FIG. 4 is a block diagram illustrating the Wi-Fi Direct reference model for audio and video payload processing;

FIG. 5 is a diagram illustrating an encoding order and playback order of a sequence of I-frames, P-frames, and B-frames;

FIG. 6 is a schematic block diagram illustrating components employed by a graphics device for rendering native graphics commands and content;

FIG. 7 is a schematic block diagram illustrating a hybrid Miracast and native graphics thrower-catcher architecture, according to one embodiment;

FIG. 7a is a schematic block diagram illustrating a hybrid Miracast and Android graphics thrower-catcher architecture, according to one embodiment;

FIG. 8 is a schematic block diagram illustrating further details of the Miracast/Native mode switch logic and related components and operations implemented on hybrid thrower device and hybrid catcher device of FIG. 7;

FIG. 9 is a flowchart illustrating operations and logic for supporting mode switching between a Miracast mode and a native graphics throwing mode, according to one embodiment;

FIG. 9a is a flowchart illustrating operations and logic for supporting mode switching between a generalized screencasting mode and a native graphics throwing mode, according to one embodiment;

FIG. 10 is a message flow diagram illustrating messages employed by a WFD source and sink to implement mode switching between the Miracast mode and the native graphics throwing mode;

FIG. 11 is a schematic block diagram illustrating the software components as defined by the Android architecture;

FIG. 12 is a schematic block and data flow diagram illustrates selected Android graphics components and data flows between them;

FIG. 13 is a schematic block and data flow diagram illustrating selected components of the Android graphics system and compositing of graphics content by Android's SurfaceFlinger and Hardware Composer;

FIG. 14a is a schematic block diagram illustrating a configuration for implementing a Wi-Fi Direct link over an Ethernet physical link;

FIG. 14b is a schematic block diagram illustrating a configuration for implementing a Wi-Fi Direct link over a USB link;

FIG. 15a illustrates a generalize hardware and software architecture for a hybrid Miracast and native graphics thrower device, according to one embodiment;

FIG. 15b illustrates a generalize hardware and software architecture for a hybrid Miracast and native graphics catcher device, according to one embodiment; and

FIG. 16 is a schematic diagram of a mobile device configured to implement aspects of the hybrid Miracast and native graphics thrower and catcher embodiments described and illustrated herein.

### DETAILED DESCRIPTION

Embodiments of methods and apparatus for implementing a mode-switch protocol and mechanism for hybrid wireless display system with screencasting and native graphics throwing are described herein. In the following description, numerous specific details are set forth (such as embodiments employing Miracast) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

As used in any embodiment herein, the term “module” may refer to software, firmware and/or circuitry that is/are configured to perform or cause the performance of one or more operations consistent with the present disclosure. Software may be embodied as a software package, code, instructions, instruction sets and/or data recorded on non-transitory computer readable storage mediums. Firmware may be embodied as code, instructions or instruction sets and/or data that are stored in nonvolatile memory devices, including devices that may be updated (e.g., flash memory). “Circuitry”, as used in any embodiment herein, may comprise, for example, singly or in any combination, hardwired circuitry, programmable circuitry such as computer processors comprising one or more individual instruction processing cores, state machine circuitry, software and/or firmware that stores instructions executed by programmable circuitry.

For the sake of clarity and ease of understanding, the present disclosure often describes computing devices as including one or more modules stored in a memory, wherein the module(s) include(s) computer readable instructions which when executed by a processor of the pertinent device, cause the device to perform various operations. It should be understood that such descriptions are exemplary, and that computing devices may be configured to perform operations described in association with one or more modules in another manner. By way of example, the computing devices described herein may include logic that is implemented at least in part in hardware to cause the performance of one or more operations consistent with the present disclosure, such as those described in association with various modules identified herein. In this regard, it is noted that “logic” as used herein may include discrete and/or analog circuitry, including for example, a general-purpose processor, digital signal processor (DSP), system on chip (SoC), state machine circuitry, hardwired circuit elements, application specific integrated circuits, combinations thereof, and the like.

In accordance with aspects of the embodiments described and illustrated herein, techniques for implementing a mode-switch protocol and mechanism for a hybrid wireless display system with screencasting and native graphics throwing are enabled. To better appreciate the advantage of using a hybrid wireless display system, a brief review of the desired attributes of such systems follows.

Ideally, a wireless display system should provide the following attributes:
1. Low latency for interactive usages
2. Low bandwidth consumption on the wireless link, efficient use of wireless link
3. Low power consumption on battery operated mobile Source devices such as Phones/Tablets
4. Near lossless image quality, especially for productivity and interactive usages
5. Displays all applications and content (Premium/DRM AV content, personal/free content) without exception, and without performance degradation.

Since a screencasting technology, such as Miracast's frame buffer mirroring scheme, is independent of how the display content is generated, it supports most of attribute 5. However, it fails to deliver attributes 1-4, and depending on the content it may have noticeable performance degradation. For example, the sequence of screen buffer frame capture, compress and encode, decode and decompress, and frame regeneration produces a noticeable lag, and if there is a lot of motion in the content there are undesirable artifacts produced when the frames are displayed on the playback device. Miracast also requires a high-bandwidth link that results in higher than desirable power consumption.

Miracast fundamentally uses a raster graphics approach, which is advantageous for raster-graphics based content, such as video content. However, the vast majority display content (what is displayed on the screen) of mobile devices such as smartphones and tablets is vector-based content and/or is content that is generated using GPU (Graphics Processor Unit) rendering commands and GPU-related rendering facilities. For example, a typical application running on a smartphone or tablet has a graphics user interface (GUI) that is defined by one or more graphic library APIs (Application Program Interfaces). The native graphics libraries employ vector graphics rendering techniques for rendering graphical content such as geometric shapes and line art, in combination with text-rendering using scalable fonts and provisions for supporting image rendering. In addition, the native graphics architectures leverage graphics processing capabilities provided by a GPU (or even multiple GPUs) to further enhance graphics rendering performance.

Under embodiments herein, a best of both worlds approach is used to implement a wireless display system having attributes 1-5. The attributes are met through a hybrid approach that employs Miracast for raster content, while “throwing” native graphics commands for native application content.

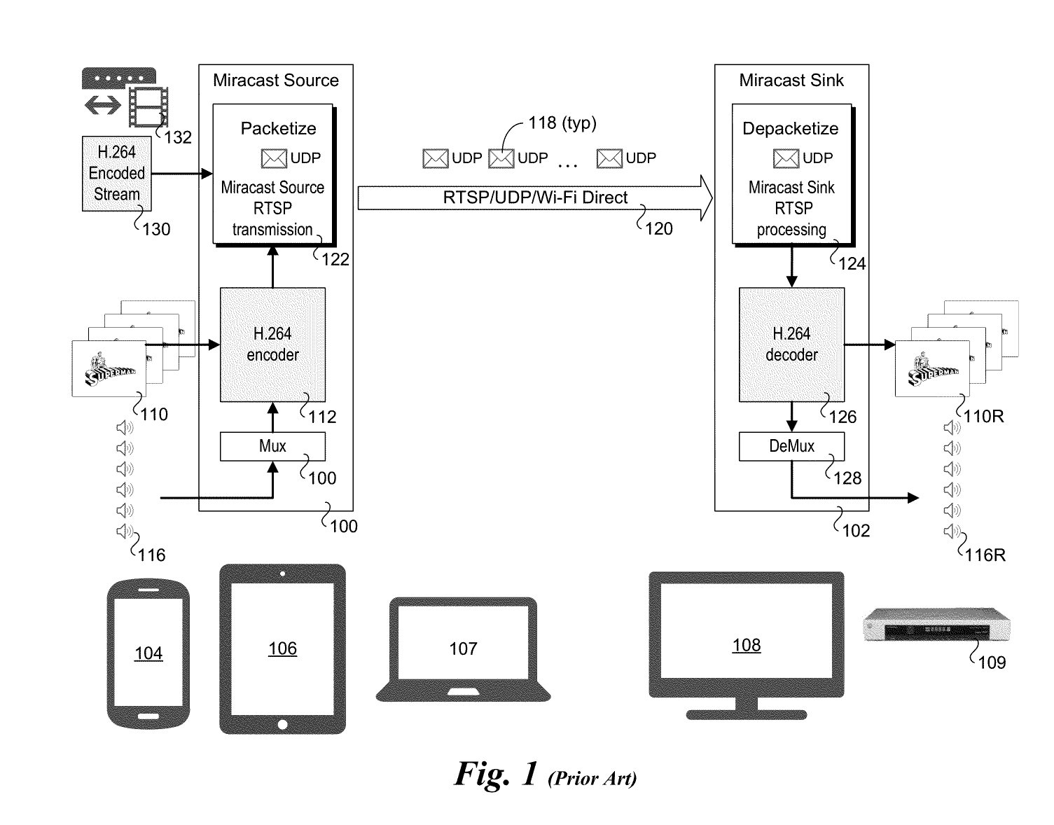

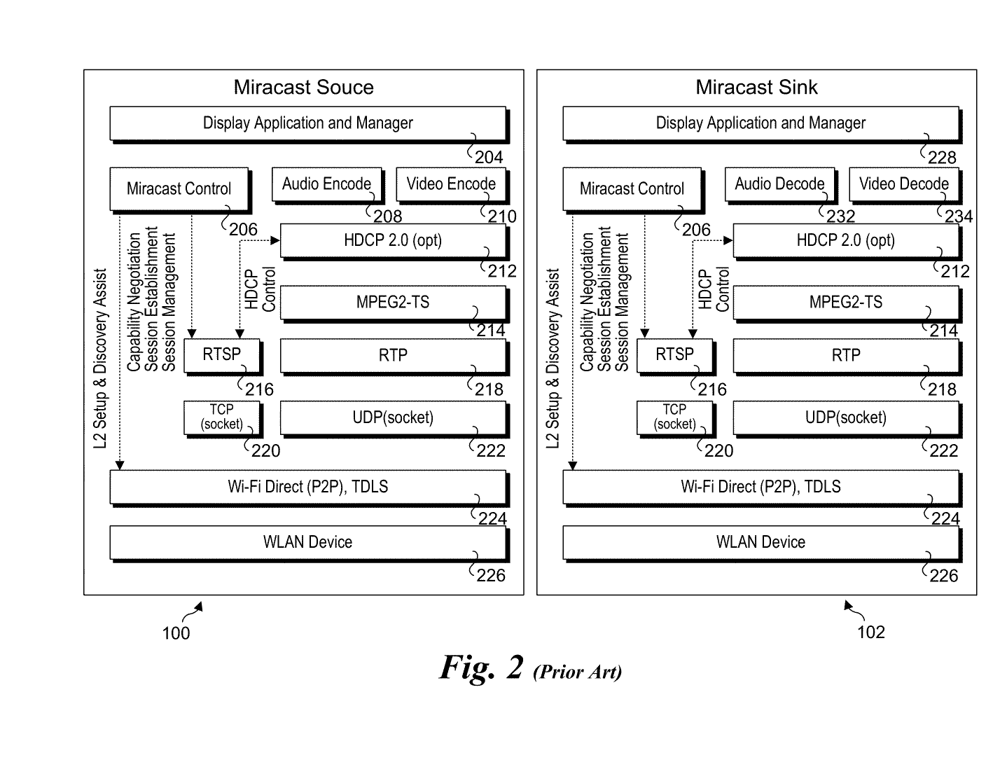

To better appreciate the difference between Miracast's approach for wireless remote display and approaches that throw native graphics commands, details of how Miracast works are first discussed. As shown in FIG. 1, the primary components of Miracast are a Miracast source 100 and a Miracast sink 102. A Miracast source is the screencasting device, such as depicted by a mobile phone 104, a tablet 106, and a laptop 107, while the Miracast sink is the device that receives and renders the screencast content, as depicted by an HDTV 108 and a set-top box 109. Generally, there is no limit to what type of device may be implemented for a Miracast source and sink, and the examples illustrated in FIG. 1 are exemplary and non-limiting.

Miracast encodes display frame content 110 captured from the frame buffer of the Miracast source using an H.264 encoder 112. Audio content 114 may also be sampled and multiplexed into the H.264 encoded output, as depicted by a multiplexer (Mux) 116. H.264 encoder 112 generates an H.264 encoded bitstream that is then encapsulated into a sequence of UDP packets 118 that are transmitted over a Wi-Fi direct wireless link 120 using the Real-Time Streaming Protocol (RTSP) over a Real-time Transport Protocol (RTP) connection. At Miracast source 100, the H.264 encoded bitstream output of H.246 encoder 112 is received and processed by a Miracast source RTSP transmission block 122, which packetizes the H.264 encoded bitstream into UDP packets 118. These packets are then transmitted in sequence over Wi-Fi Direct wireless link 120 using RTSP to Miracast sink 102, where they are received and processed by a Miracast sink RTSP processing block 124. The received UPD packets 118 are de-packetized to extract the original H.264 bitstream, which is forwarded to an H.264 decoder 126. H.264 decoder 126 decodes the H.264 encoded bitstream to reproduce the original frames 110, as depicted by frames 110R. If the H.264 encoded bitstream includes audio content, that content is also decoded by H.264 decoder 126, and demultiplexed by a demux 128 to reproduce the original audio content 116, as depicted by audio content 116R.

As another option, a Miracast source can be configured to directly stream an H.264 encoded Miracast-compatible video stream without playing the video and capturing video frames and audio samples on the Miracast source device. For example, this is depicted in FIG. 1 as an H.264 encoded video stream 130 that is streamed from a video gateway 132. Under some implementations, a Miracast source may be configured to display a video player interface including video controls (e.g., play, pause, rewind, fast forward, etc.), but not display the video content that is streamed to the Miracast sink, which is used for playback and display of the video content.

FIG. 2 shows further details of the stacks implemented for Miracast source 100 and sink 102. Miracast source 102 includes a display application and manager block 204 a Miracast control block 206, an audio encode block 208, a video encode block 210, an optional HDCP (High-bandwidth Digital Content Protection) 2.0 block 212, an MPEG2-TS (Moving Picture Experts Group-Transport Stream) block 214, an RTSP block 216, an RTP block 222, a TCP (Transmission Control Protocol) socket 220, a UDP (Universal Datagram Protocol) socket 222, a Wi-Fi Direct/TDLS (Tunneled Direct Link Setup) block 224, and a WLAN (Wireless local area network) device block 226. Miracast sink 102 includes a display application and manager block 228, and Audio decode block 232, and a video decode block 234. Miracast sink 102 further includes similar components with Miracast source 100, as indicated by same reference numbers.

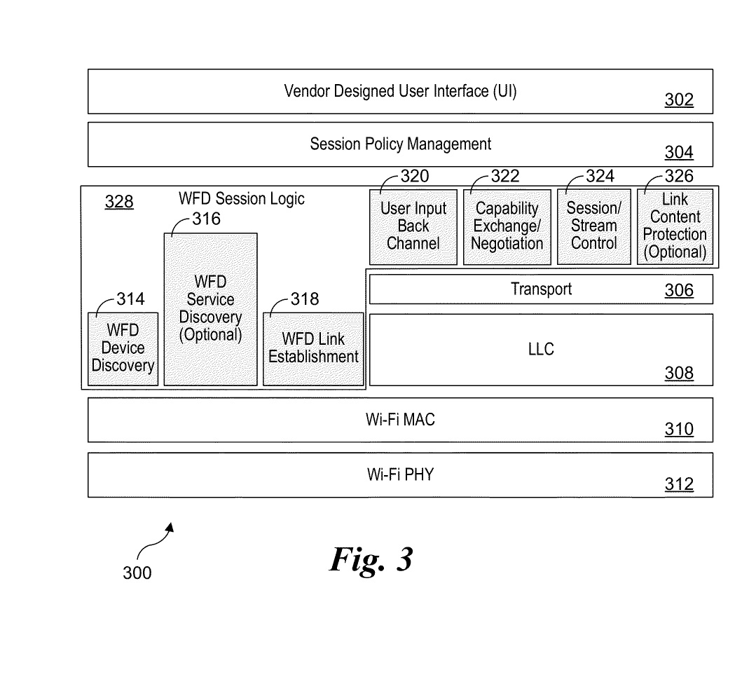

FIG. 3 shows a reference model 300 for session management of a Wi-Fi Direct (WFD) Source and WDF Sink. This conceptual model includes a set of predefined functions, presentation, control, and transport blocks and layers. These include a vender designed user interface (UI) layer 302, a session policy management layer 304, a transport layer 306, a Logical Link control (LLC) layer 308, a Wi-Fi Media Access Control (MAC) layer 310, and a Wi-Fi Physical Layer (PHY) 312.

The remaining blocks are specific to implementing WFD sessions in accordance with the Wi-Fi Display Technical Specification Version 1.0.0, as defined by the Wi-Fi Alliance Technical Committee and the Wi-Fi Display Technical Task Group. These include a WFD device discovery block 314, an optional WFD service discovery block 316, a WFD link establishment block 318, a user input back channel 320, a capability exchange/negotiation block 322, a session/steam control block 324, and an optional link content protection block 326. These WFD components collectively comprise WFD session logic 328.

At a high level, a user interface on a WFD Source and/or a WFD Sink presents the discovered WFD Devices to the user via a user interface so that the user may select the peer device to be used in a WFD Session. Once device selection is performed by the user, a WFD Connection is established and the transport layer is used to stream AV (Audio Video) media from a WFD Source to a peer WFD Sink.

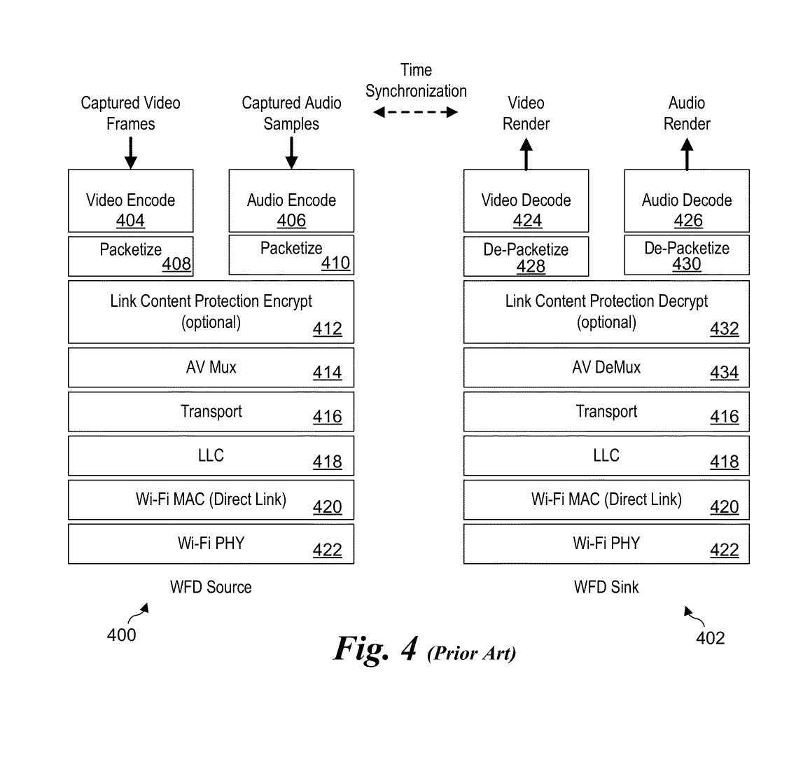

FIG. 4 depicts the Wi-Fi Direct (WFD) reference model for audio and video payload processing. The WFD source 400 includes a video encode block 404, and audio encode block 406, packetize blocks 408 and 410, an optional link content protection encryption block 412 and AV Mux block 414, a transport block 416, an LLC block 418, a Wi-Fi MAC layer 420, and a Wi-Fi PHY 422. The WFD sink 402 includes a video decode block 424, an audio decode block 426, de-packetize blocks 428 and 430, an optional link content protection decryption block 432, an AV DeMux block 434, a transport block 416, an LLC block 418, a Wi-Fi MAC layer 420, and a Wi-Fi PHY 422.

The general sequence for WFD Connection Setup, WFD Session establishment, and management is as follows:
1. WFD Device Discovery: Initially, a WFD Source and a WFD Sink discover each other's presence, prior to WFD Connection Setup.
2. WFD Service Discovery: This optional step allows a WFD Source and a WFD Sink to discover each other's service capabilities prior to the WFD Connection Setup.
3. Device Selection: This step allows a WFD Source or a WFD Sink to select the peer WFD Device for WFD Connection Setup. During this step, user input and/or local policies may be used for device selection.
4. WFD Connection Setup: This step selects the method (Wi-Fi P2P or TDLS) for the WFD Connection Setup with the selected peer WFD Device and allows establishment of a WPA2-secured single hop link with the selected WFD Device.
5. WFD Capability Negotiation: This step includes a sequence of RTSP message exchanges between the WFD Source and WFD Sink(s) to determine the set of parameters that define the audio/video payload during a WFD Session.
6. WFD Session Establishment: This step establishes the WFD Session. During this step, the WFD Source selects the format of audio/video payload for a WFD Session within a capability of the WFD Sink and informs the selection to the WFD Sink.
7. User Input Back Channel Setup: This optional step establishes a communication channel between the WFD Source and the WFD Sink for transmitting control and data information emanating from user input at the WFD Sink.
8. Link Content Protection Setup: This optional step derives the session keys for Link Content Protection used for transmission of protected content.
9. Payload Control: Payload transfers are started after the above sequences are completed, and may be controlled during a WFD Session.
10. WFD Source and WFD Sink standby: This optional step enables the WFD Source and WFD Sink to manage and control power modes such as standby and resume (e.g., wake-up) while the WFD Session is maintained.
11. WFD Session Teardown: This step terminates the WFD Session.
   Further details of performing each of the foregoing operations are discussed in Wi-Fi Display Technical Specification Version 1.0.0.

A core function of a Miracast source, as detailed above, is to generate H.264 encoded streaming video content that is transferred over a Wi-Fi Direct link and played-back on a display device comprising the Miracast sink. At a basic level, streaming video content is played-back on a display as a sequence of “frames” or “pictures.” Each frame, when rendered, comprises an array of pixels having dimensions corresponding to a playback resolution. For example, full HD (high-definition) video has a resolution of 1920 horizontal pixels by 1080 vertical pixels, which is commonly known as 1080p (progressive) or 1080i (interlaced). In turn, the frames are displayed at a frame rate, under which the frame's data is refreshed (re-rendered, as applicable) at the frame rate.

At a resolution of 1080p, each frame comprises approximately 2.1 million pixels. Using only 8-bit pixel encoding would require a data streaming rate of nearly 17 million bits per second (mbps) to support a frame rate of only 1 frame per second if the video content was delivered as raw pixel data. Since this would be impractical, video content is encoded in a highly-compressed format.

Still images, such as viewed using an Internet browser, are typically encoded using JPEG (Joint Photographic Experts Group) or PNG (Portable Network Graphics) encoding. The original JPEG standard defines a “lossy” compression scheme under which the pixels in the decoded image may differ from the original image. In contrast, PNG employs a “lossless” compression scheme. Since lossless video would have been impractical on many levels, the various video compression standards bodies such as the Motion Photographic Expert Group (MPEG) that defined the first MPEG-1 compression standard (1993) employ lossy compression techniques including still-image encoding of intra-frames (“I-frames”) (also known as “key” frames) in combination with motion prediction techniques used to generate other types of frames such as prediction frames (“P-frames”) and bi-directional frames (“B-frames”). Similarly, H.264 also employs I-frames, P-frames, and B-frames, noting there are differences between MPEG and H.264, such as how the frame content is generated.

While video and still-image compression algorithms share many compression techniques, a key difference is how motion is handled. One extreme approach would be to encode each frame using JPEG, or a similar still-image compression algorithm, and then decode the JPEG frames to generate frames at the player. JPEGs and similar still-image compression algorithms can produce good quality images at compression ratios of about 10:1, while advanced compression algorithms may produce similar quality at compression ratios as high as 30:1. While 10:1 and 30:1 are substantial compression ratios, video compression algorithms can provide good quality video at compression ratios up to approximately 200:1. This is accomplished through use of video-specific compression techniques such as motion estimation and motion compensation in combination with still-image compression techniques.

For each macro block in a current frame (typically an 8×8 or 16×16 block of pixels), motion estimation attempts to find a region in a previously encoded frame (called a “reference frame”) that is a close match. The spatial offset between the current block and selected block from the reference frame is called a “motion vector.” The encoder computes the pixel-by-pixel difference between the selected block from the reference frame and the current block and transmits this “prediction error” along with the motion vector. Most video compression standards allow motion-based prediction to be bypassed if the encoder fails to find a good match for the macro block. In this case, the macro block itself is encoded instead of the prediction error.

It is noted that the reference frame isn't always the immediately-preceding frame in the sequence of displayed video frames. Rather, video compression algorithms commonly encode frames in a different order from the order in which they are displayed. The encoder may skip several frames ahead and encode a future video frame, then skip backward and encode the next frame in the display sequence. This is done so that motion estimation can be performed backward in time, using the encoded future frame as a reference frame. Video compression algorithms also commonly allow the use of two reference frames—one previously displayed frame and one previously encoded future frame.

Video compression algorithms periodically encode intra-frames using still-image coding techniques only, without relying on previously encoded frames. If a frame in the compressed bit stream is corrupted by errors (e.g., due to dropped packets or other transport errors), the video decoder can “restart” at the next I-frame, which doesn't require a reference frame for reconstruction.

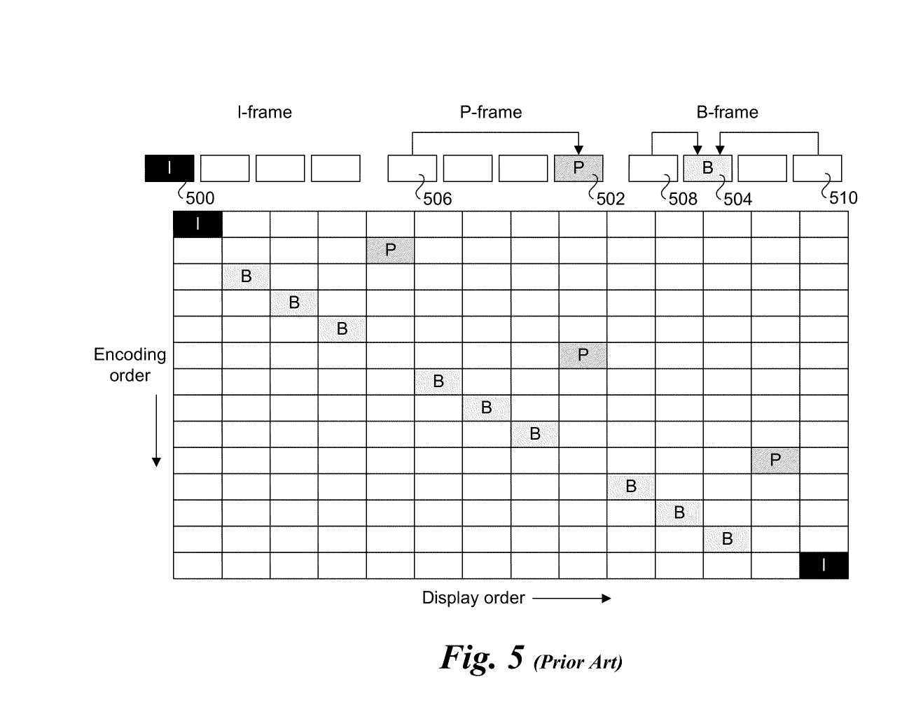

FIG. 5 shows an exemplary frame encoding and display scheme consisting of I-frames 500, P-frames 502, and B-frames 504. As discussed above, I-frames are periodically encoded in a manner similar to still images and are not dependent on other frames. P-frames (Predicted-frames) are encoded using only a previously displayed reference frame, as depicted by a previous frame 506. Meanwhile, B-frames (Bi-directional frames) are encoded using both future and previously displayed reference frames, as depicted by a previous frame 508 and a future frame 510.

The lower portion of FIG. 5 depicts an exemplary frame encoding sequence (progressing downward) and a corresponding display playback order (progressing from left to right). In this example, each P-frames is followed by three B-frames in the encoding order. Meanwhile, in the display order, each P-frame is displayed after three B-frames, demonstrating that the encoding order and display order are not the same. In addition it is noted that the occurrence of P-frames and B-frames will generally vary, depending on how much motion is present in the captured video; the use of one P-frame followed by three B-frames herein is for simplicity and ease of understanding how I-frames, P-frames, and B-frames are implemented.

Without even considering H.264 processing latencies, the fact that H.264 I-frames, P-frames, and B-frames are encoded in a different order than they are played back necessitates significant latencies. For example, at a nominal frame rate of 30 frames per second (fps), a high-motion section of video may require P-frames that are processed by considering 15 or more prior frames. This results in a latency just at the H.264 encoder side of ½ second or more. Adding the latencies resulting from additional processing operations may yield a delay of more than one second, or even several seconds for Miracast sources that support lower frame rates (e.g., 15 fps) and/or higher-resolution content. Such latencies, as well as noticeable artifacts in the playback display content are exacerbated for high-motion content. As a result, Miracast is totally impractical for remote display of content requiring real-time feedback, such as gaming applications.

In further detail, gaming application on mobile devices typically use OpenGL drawing commands and associated libraries and APIs. Moreover, the OpenGL libraries and APIs are configured to be processed by the GPU(s) on the mobile devices, such as on Android devices, which currently support OpenGL ES (embedded system) 3.0. OpenGL ES includes a drawing command API that supports generation of various types of vector graphics-based content and raster-based textures that may further be manipulated via a GPU or the like (noting it is also possible to render OpenGL content using a software-rendering approach, albeit at speeds that are significantly slower than GPU rendering).

The internal architecture of a GPU is configured to support a massive number of parallel operations, and GPUs are particularly well-adapted at performing complex manipulation of graphics content using corresponding graphics commands (such as OpenGL drawing commands). For example, graphics content may be scaled, rotated, translated and/or skewed (one or more at a time) by issuing graphic commands to modify transformation matrixes. Through the use of mathematical operations comprising affine transformations and similar operations, the GPU can produce amazing graphics effect in real-time.

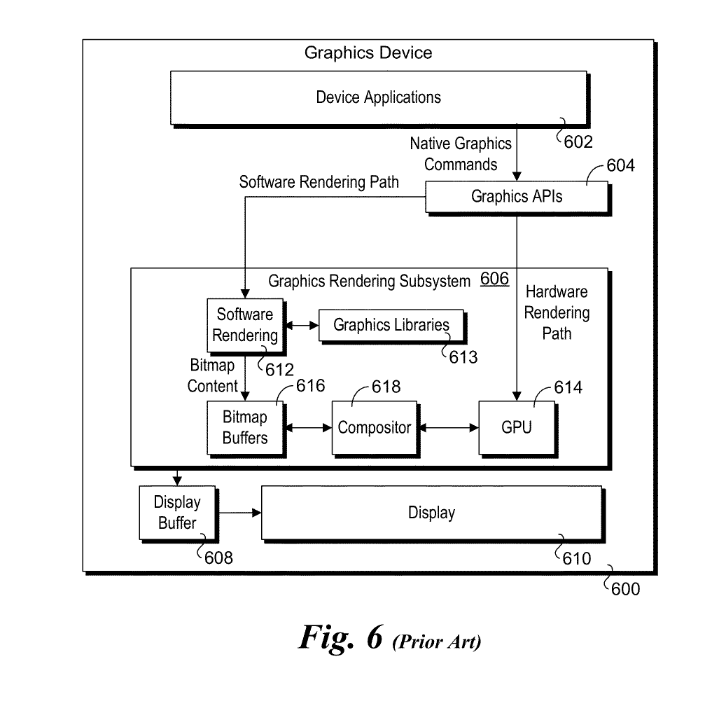

FIG. 6 illustrates an abstracted graphics rendering architecture of a generic graphics device 600, which includes device applications 602, graphic APIs 604, a graphics rendering subsystem 606, a display buffer 608, and a display 610. Device applications 602 running on the graphic device's operating system issue native graphics commands to graphics APIs 604. The native graphics commands generally comprise any graphic command that may be used for rendering content on a given platform or device, and is not limited to a particular set of APIs in this graphics architecture. For example, the native graphic commands may generally include any graphics command that is supported by the operating system/device implementation; more specific details of exemplary APIs are discussed below.

Graphic APIs 604 are configured to support two rendering paths: 1) a software rendering path; and 2) a hardware rendering path. The software rendering path involves use of software executing on the graphics device's host processor, such as a central processing unit (CPU), as depicted by software rendering 612. Generally, this will be implemented via one or more run-time graphics libraries 613 that are accessed via execution of corresponding graphic APIs 604. In contrast, the hardware rendering path is designed to render graphics using one or more hardware-based rendering devices, such as a GPU 614. While internally a GPU may use embedded software (not shown) for performing some of its operations, such embedded software is not exposed via a graphics library that is accessible to device applications 602, and thus rendering graphics content on a GPU is not considered software rendering.

Graphics rendering subsystem 606 is further depicted to include bitmap buffers 614, and a compositor 618. Software rendering generally entails rendering graphics content as bitmaps that comprise virtual drawing surfaces or the like that are allocated as bitmap buffers 616 in memory (e.g., system memory). Depending on the terminology used by the software platform for graphics device 600, the bitmap buffers are typically referred to layers, surfaces, views, and/or windows. For visualization purposes, imagine a bitmap buffer as a virtual sheet of paper having an array of tiny boxes onto which content may be “painted” by filling the boxes with various colors.

GPU 614 renders content using mathematical manipulation of textures and other content, as well supporting rendering of vector-based content. GPU 614 also uses bitmap buffers, both internally (not shown), as well as in memory. This may include system memory, memory that is dedicated to the GPU (either on-die memory or off-die memory), or a combination of the two. For example, if the GPU is included in a graphics card in a PC or a separate graphics chip in a laptop, the graphics card or graphics chip will generally include memory that is dedicated for GPU use. For mobile devices such as smartphones and tables, the GPU is actually embedded in the processor SoC, and will typically employ some on-die memory as well as memory either embedded on the SoC or on a separate memory chip.

Compositor 618 is used for “composing” the final graphics content that is shown on the graphic device's display screen. This is performed by combining various bitmap content in bitmap buffers 616 and buffers rendered by GPU 614 (not shown) and writing the composed bitmap content into display buffer 608. The display buffer 616 is then read out using a refresh rate to cause bitmap graphical content to be displayed on a display 618. Optionally, graphics content may be written to a “back” buffer or “backing store”, which is then copied into the display buffer, or a “ping-pong” scheme may be used in which the back buffer and display buffer are swapped in concert with the refresh rate.

In accordance with aspects of embodiments herein, devices are disclosed to support “throwing” native graphics commands using a Wi-Fi Direct link wirelessly coupling a device that transmits the native graphics commands (the “thrower” or “throwing” device, comprising a WFD source) and a device that receives and renders the native graphics commands (the “catcher” or “catching” device, comprising a WFD sink). Under one approach, the graphics rendering subsystem components that are employed by a graphics device, such as a smartphone, tablet, personal computer, laptop computer, Chromebook, netbook, etc. are replicated on the catching device.

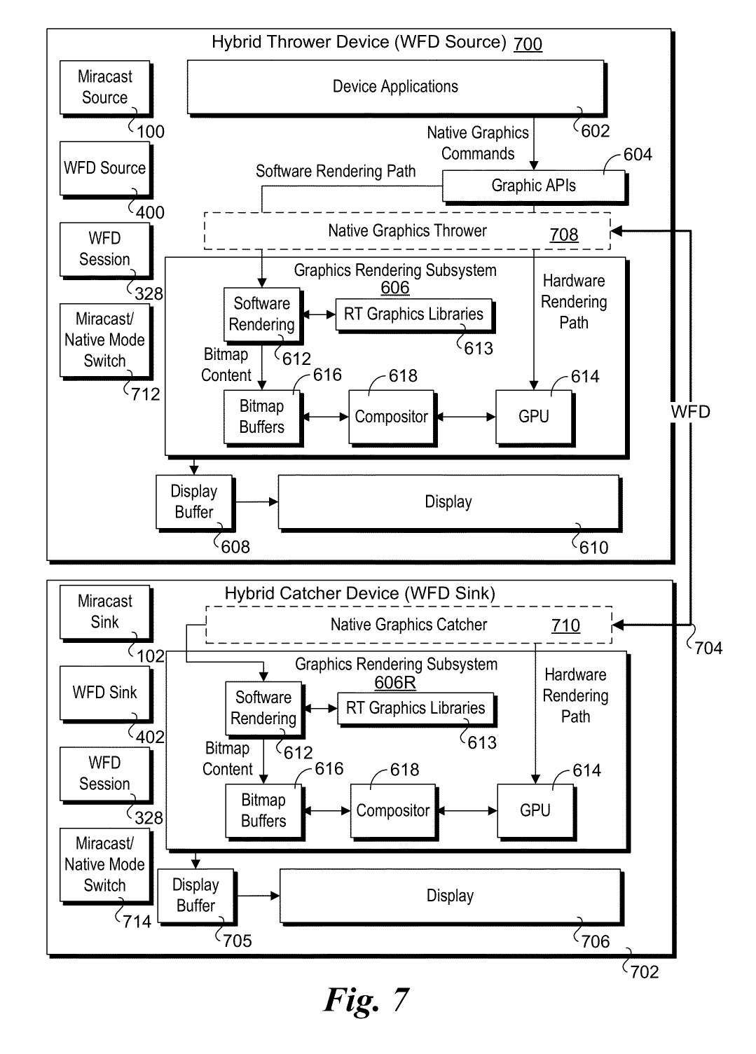

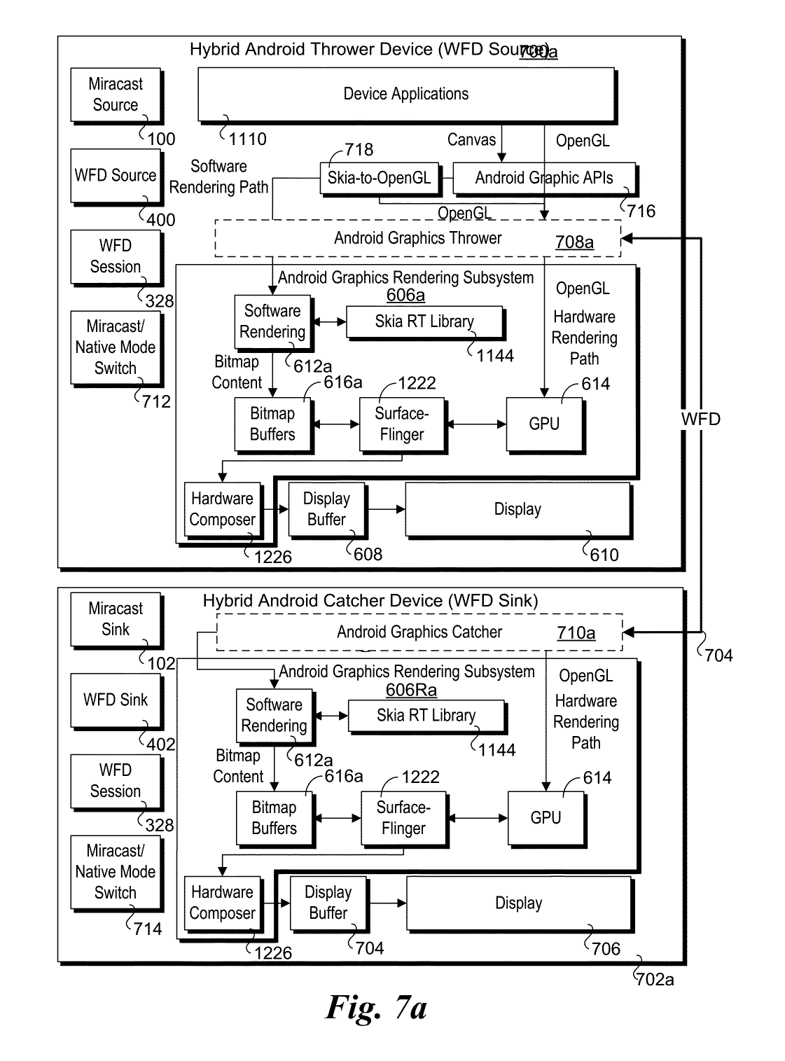

An exemplary hybrid Miracast and native graphics thrower-catcher architecture is shown in FIG. 7 including a hybrid thrower device 700 that streams Miracast content and throws native graphics commands and content to a hybrid catcher device 702 via a Wi-Fi Direct link 704. Generally, as used herein, “Miracast content” corresponds to the content that is encoded by the Miracast Source, while Miracast-suitable content is any content that is suitable for displaying remotely using Miracast, which will typically include raster-based content such as movies, photos, as well as application that generate or use a significant amount of raster-based content. As indicated by like reference numbers in FIGS. 6 and 7, the graphics architecture of hybrid thrower device 700 is similar to the graphics architecture of graphics device 600. Meanwhile, components comprising graphics rendering subsystem 606 are replicated on hybrid catcher device 702, as depicted by graphics rendering subsystem 606R. Hybrid catcher device 702 further includes a display buffer 705 and a display 706 that generally function in a similar manner to display buffer 608 and display 610, but may have different buffer sizes and/or configurations, and the resolution of display 706 and display 610 may be the same or may differ.

Throwing of native graphics commands and content is enabled by respective thrower and catcher components on hybrid thrower device 700 and hybrid catcher device 700 comprising a native graphics thrower 708 and a native graphics catcher 710. These components help facilitated throwing of native graphics commands and content in the following manner.

In one embodiment, native graphics thrower 708 is implemented as a virtual graphics driver or the like that provides an interface that is similar to graphics rendering subsystem 606. Graphic commands and content corresponding to both the software rendering path and hardware rendering path that are output from graphic APIs 604 are sent to native graphics thrower 708. Depending on the operating mode, native graphics thrower 708 may be configured as a trap and pass-through graphics driver, or it may operate as an intercepting graphics driver. When operating as a trap and pass-through graphics driver, native graphics commands and content is trapped, buffered, and sent to native graphics catcher 710. The buffered commands are also allowed to pass through to graphics rendering subsystem 606 in a transparent manner such that the graphics on hybrid thrower device 700 appear to operate the same as graphics device 600. Under an intercepting graphics driver, the graphics commands are not passed through, which is similar to how some content is rendered when using Miracast or Apple TV and Airplay. For example, when screencasting a movie that is initially played on an iPad, once the output device is switched to AppleTV, the movie no longer is presented on the iPad, although controls for controlling playback via the iPad are still provided.

As will be readily observed, the thrower-catcher architecture of FIG. 7 implements a split graphics architecture, with the graphics rendering subsystem “moved” to the hybrid catcher device. From the perspective of graphics rendering subsystem 606R, native graphics catcher 710 output graphics commands and content along both the software (SWF) and hardware rendering paths as if this content was provided directly by graphic APIs 604. The result is that graphics content can be rendered on the remote wireless device (i.e., hybrid catcher device 702) at a similar speed to graphics rendered on a graphics device itself (when similar hardware components are implemented for graphics rendering subsystems 606 and 606R). There is substantially no latency incurred through the graphic commands and content throwing process, and the amount of lag resulting from such latency is generally unperceivable to the user, particular for graphics commands and content that is rendered via the hardware rendering path. The greatest amount of latency will typically involve throwing a large image (e.g., a large JPEG or PNG image), which may be implemented by transferring the compressed image file itself from the thrower to the catcher.

In addition to throwing and catching native graphics commands and content, hybrid thrower device 700 and hybrid catcher device 702 are configured to function as Miracast and WFD sources and sinks. Accordingly, hybrid thrower device 700 include components for implementing a Miracast source 100, a WFD source 400, source-side WFD session logic 328 and source-side Miracast/Native mode switch logic 712. Meanwhile, hybrid catcher device 702 includes component for implementing a Miracast sink 102, a WFD sink 402, sink-side WFD session logic 328, and a sink-side Miracast/Native mode switch logic 714.

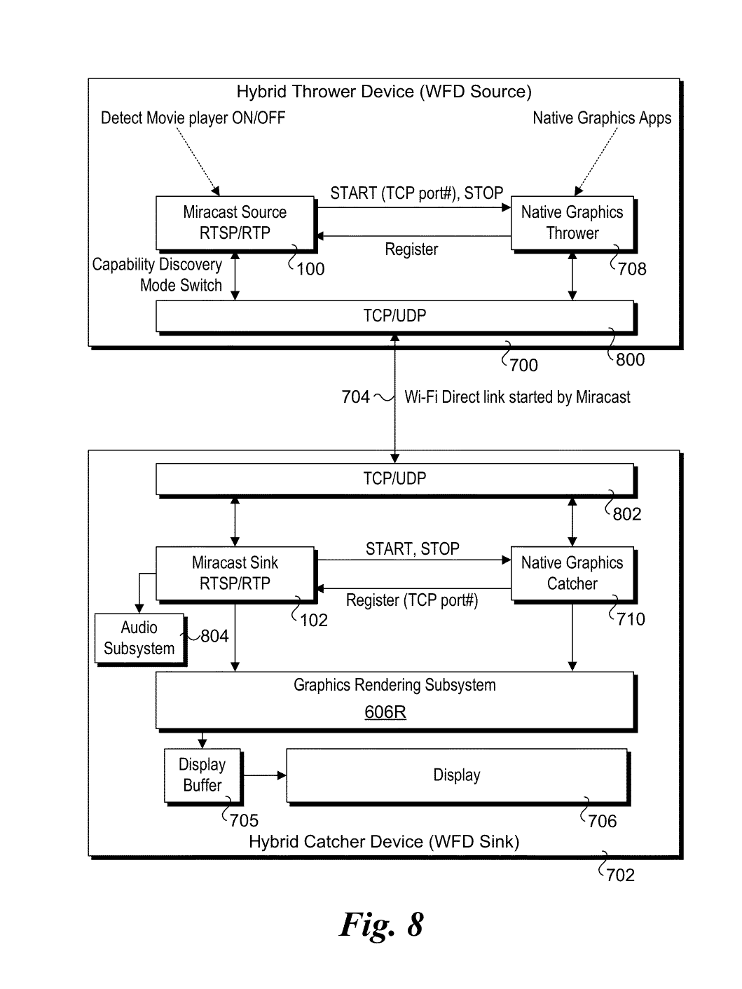

FIG. 8 shows further details of the Miracast/Native mode switch logic and related components and operations implemented on hybrid thrower device 700 and hybrid catcher device 702, according to one embodiment. Hybrid thrower device 700 includes Miracast source 100 components, native graphics thrower 708, and a TCP/UDP block 800. Hybrid catcher device 702 includes a TCP/UDP block 802, Miracast sink 102 components, a native graphics catcher 710, an audio subsystem 804, a graphics rendering subsystem 606R, a display buffer 705, and a display 706. It will be recognized that each of hybrid thrower device 700 and hybrid catcher device 702 will include further components discussed and illustrated elsewhere herein.

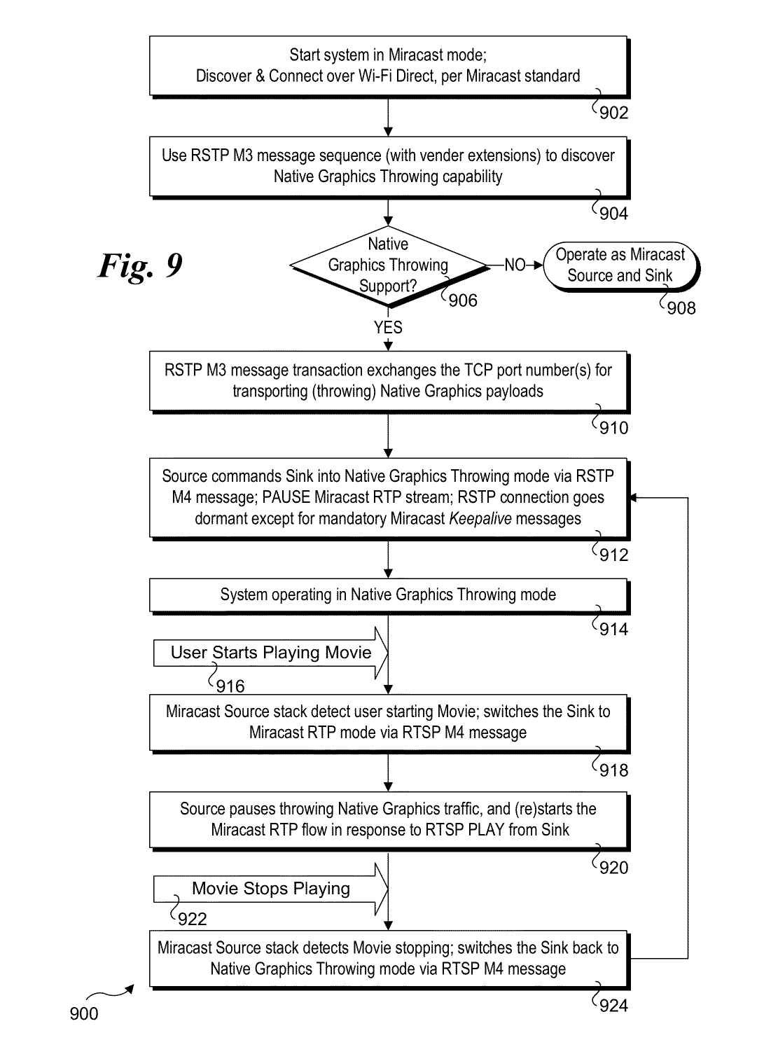

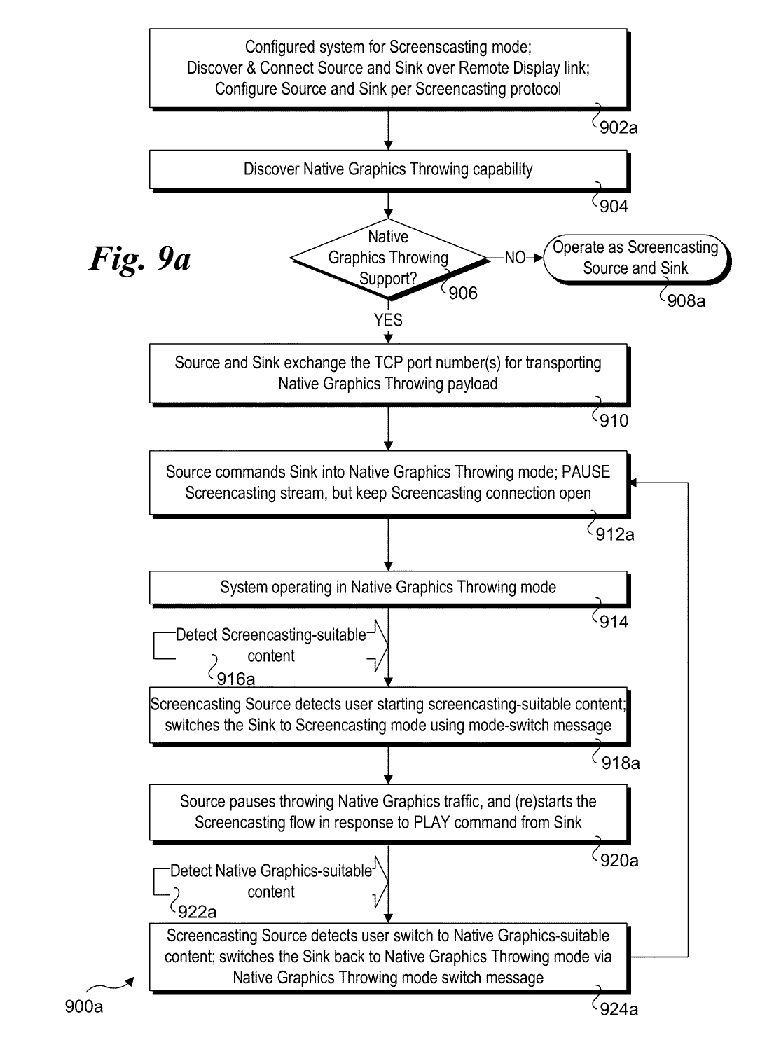

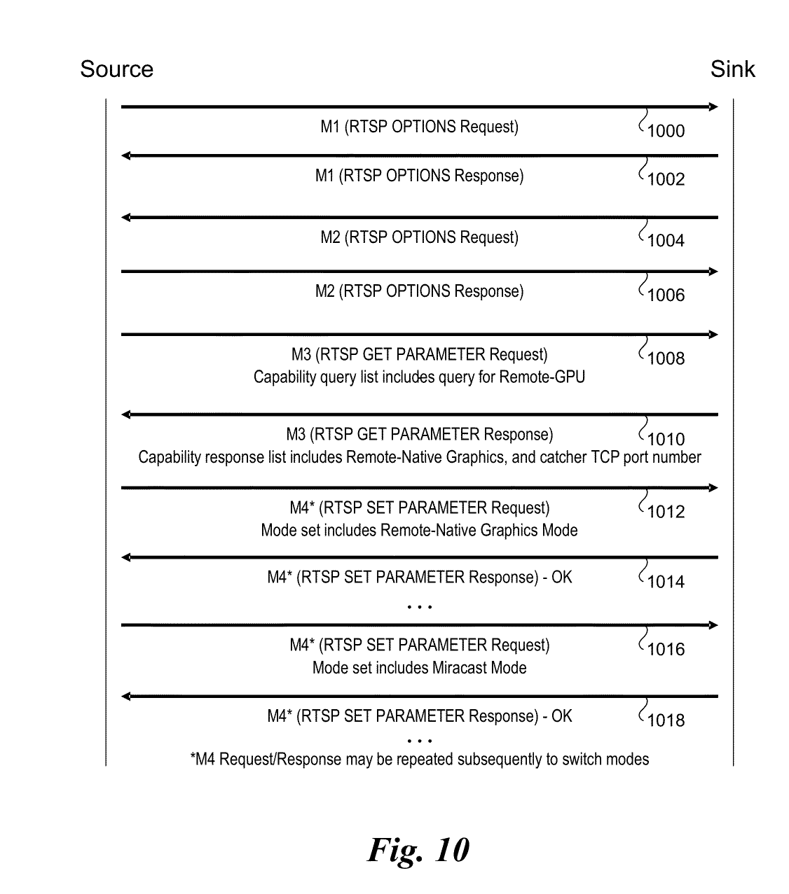

FIG. 9 shows a flowchart 900 illustrating operations and logic for supporting mode switching between a Miracast mode and a throwing Native Graphic throwing mode. The process starts in a block 902, wherein the wireless display system is started in Miracast mode. This involves a Wi-Fi Direct discovery and connection procedure that is implemented via an exchange of messages between the WFD source and sink, as defined in Wi-Fi Display Technical Specification Version 1.0.0, or a subsequent version of this specification. As shown in FIG. 10, this includes exchange of RTSP M1 and M2 (RTSP Options Request) messages. First, the WFD source (hybrid thrower device 700) sends an M1 RTSP OPTIONS request message 1000 in order to determine the set of RTSP methods supported by the WFD sink (hybrid catcher device 702). On receipt of an RTSP M1 (RTSP OPTIONS) request message 1000 from the WFD Source, the WFD Sink responds with an RTSP M1 (RTSP OPTIONS) response message 1002 that lists the RTSP methods supported by the WFD Sink.

After a successful RTSP M1 message exchange, the WFD Sink sends an M2 RTSP OPTIONS request message 1004 in order to determine the set of RTSP methods supported by the WFD Source. On receipt of an RTSP M2 (RTSP OPTIONS) request message 1004 from the WFD Sink, the WFD Source responds with an RTSP M2 (RTSP OPTIONS) response message 1006 that lists the RTSP methods supported by the WFD Source.

In a block 904, an RTSP M3 message sequence is implemented to discover whether remote native graphics capability is supported. In one embodiment this is implemented using vendor extensions to the standard RTSP M3 message. After a successful RTSP M2 exchange, the WFD Source sends an RTSP GET_PARAMETER request message 1008 (RTSP M3 request), explicitly specifying the list of WFD capabilities that are of interest to the WFD Source. Standard capabilities may be extended by using optional parameters, which in this instance include a parameter corresponding to remote native graphics support. When an optional parameter is included in the RTSP M3 Request message from the WFD Source, it implies that the WFD Source supports the optional feature corresponding to the parameter.

The WFD Sink responds with an RTSP GET_PARAMETER response message 1010 (RTSP M3 response). The WFD Source may query all parameters at once with a single RTSP M3 request message or may send separate RTSP M3 request messages.

In a decision block 906 a determination is made to whether native graphics throwing is supported. If it is not (answer NO), the WFD source and sink are operated as a Miracast source and sink in the conventional manner, as depicted by a completion block 908. If remote graphics are supported, then in a block 910 an additional RTSP M3 response-request message transaction is used to exchange the TCP port number(s) for transporting (i.e., throwing) native graphics payloads. It is preferable to confirm delivery of native graphics commands and content, and thus a TCP connection is employed rather than the UDP connection used to stream Miracast content. Since the TCP connection is used for sending both native graphics payloads and control information, specific TCP port number(s) are exchanged during this RTSP M3 response-request message transaction

At this point, hybrid thrower device 700 and hybrid catcher device 702 are configured to support Miracast H.264 streaming and throw native graphics commands and content, and the system is set to operate in the Miracast mode. In a block 912, the WFD source (hybrid thrower device 700) commands the WFD sink (hybrid catcher device 702) to switch into remote native graphics mode via an RTSP M4 message exchange, as depicted by an M4 RTSP SET PARAMETER Request message 1012 and a M4 RTSP SET PARAMETER Response message 1014. The M4 RTSP SET PARAMETER Request message 1012 mode set includes the remote native graphics mode.

In accordance with the Wi-Fi Display Technical Specification Version 1.0.0, The format of the M4 request message varies depending on the WFD Session:
(a) If the WFD Source is trying to initiate the establishment of an audio-only WFD Session with the WFD Sink, the RTSP M4 request message (or a series of RTSP M4 request messages) shall include a wfd-audio-codecs parameter and shall not include any of the following parameter: wfd-video-formats, wfd-3d-formats, or wfd-preferred-display-mode.
(b) If the WFD Source is trying to initiate the establishment of a video-only WFD Session with the WFD Sink, the RTSP M4 request message (or a series of RTSP M4 request messages) shall not include a wfd-audio-codecs parameter and shall include only one of the following parameters: wfd-video-formats, wfd-3d-formats, or wfd-preferred-display-mode.
(c) If the WFD Source is trying to initiate the establishment of an audio and video WFD Session with a Primary Sink, the RTSP M4 request message (or a series of RTSP M4 request messages) shall include a wfd-audio-codecs parameter and only one of the following parameters: wfd-video-formats, wfd-3d-formats, or wfd-preferred-display-mode.
   The wfd-preferred-display-mode parameter is set to remote native graphics when switching to remote native graphics mode. Upon completion of the RTSP M4 message exchange, the Miracast RTP stream is PAUSEd, and the RTSP connection goes dormant except for mandatory Miracast Keepalive messages. At this point, the wireless display system is operating in native graphics throwing mode, as depicted in a block 914, and remote native graphics commands and content are transported from hybrid thrower device 700 to hybrid catcher device 702 over the TCP connection via Wi-Fi direct link 704.

While operating in native graphics throwing mode, an event 916 occurs when a user of hybrid thrower device 700 starts playing a movie or other type of Miracast-suitable content. In response, in a block 918 the Miracast source 100 stack detects the user starting the movie or other type of Miracast-suitable content, and switches the sink (hybrid catcher device 702) to Miracast RTP mode via an exchange of RTSP M4 request and response messages 1016 and 1018. In this case, the wfd-preferred-display-mode parameter is set to Miracast mode when switching from remote native graphics mode to Miracast mode. In a block 920, the source pauses throwing native graphics traffic, and (re)starts the Miracast RTP flow in response to RTSP PLAY from the sink. This switches the wireless display system to Miracast mode.

At some subsequent point in time, the movie (or other Miracast-suitable content) stops playing, as depicted by an event 922. In response, in a block 924 the Miracast source 100 stack detects the movie/other Miracast-suitable content stopping, and switches the sink (hybrid catcher device 702) back to the native graphics throwing mode, and the logic returns to block 912 to complete the mode switch operation.

FIG. 8 also shows a loose software coupling on the hybrid thrower device 700 source platform between the Miracast source 100 stack and the native graphics thrower 708 stack, to achieve the mode switch. The two stacks are largely independent, except for local Registration and Mode switch indications. A similar situation exists in the hybrid catcher device 702 sink platform between the Miracast sink 102 stack and the native graphics catcher 710 stack.

During the transitions between the Miracast and remote native graphics modes, native graphics thrower 708 and native graphics catcher 710 ensure re-synchronization of the native graphics state. For example, when the native graphics content comprises OpenGL, this may be optimized (to reduce the user-perceivable delays when resuming Remote native graphics mode) by implementing texture-caching techniques.

Generally, the graphics thrower/catcher systems corresponding to the embodiments disclosed herein may be implemented as any type of device capable of performing a thrower or catcher function while also operating as a Miracast source (for the thrower) or Miracast sink (for the catcher). In a non-limiting exemplary use case, it is common for Miracast sources to include mobile devices such as smartphones, tablets, laptops, netbooks, etc., as discussed above. Meanwhile, many current smart HDTVs and UHDTVs are configured to operate a Miracasts sinks.

The operating systems used by mobile devices such as smartphones and tablets include Google's Android OS, Apple's iOS, and Microsoft Windows Mobile Phone OS. As discussed above, Android 4.2 and later devices support both Wi-Fi Direct and Miracast. Android is also an open source operating system with many public APIs that can be readily modified by those having skill in the art to extend the functionalities provided by the base version of Android provided by Google. For example, each of Samsung, HTC, LG, and Motorola have developed custom extensions to Android.

Recently, at Google I/O 2014, Google launched Android TV. Android TVs are smart TV platforms that employ Android software developed by Google (in particular, the Android TV platforms run the Android 5.0 (“Lollipop”) operating system. The Android TV platform is designed to be implemented in both TVs (e.g., HDTVs and UHDTVs), set-top boxes, as well as streaming media devices, such as Blu-ray players that support streaming media.

Under the Android TV architecture, the Android TV device is configured to receive Chromecast content sent from a Chromecast casting device, which will typically be an Android mobile device or a Chromebook. Under the Chromecast approach, a Chrome browser is implemented on the receiving device and is used to render the Chromecast content. What this means, as applied to one or more Android embodiments discussed herein, is the Android TV devices already have the Android graphics components (both software and hardware components) employed for rendering Android graphics commands and content.

Well-known HDTV and UHDTV manufacturers, including Sony and Sharp, are partnering with Google to implement and offer HDTV and UHDTV platforms in 2015, while Razer and Asus plan to release set-top boxes supporting Android TV in the near future. The first device to employ Android TV is the Nexus Player, co-developed by Google and Asus, and released in November 2014.

It is noted that there already are numerous TVs, set-top boxes, Blu-ray players, and other streaming media players that support Miracast, and Miracast support is built-into the graphics chips used for these devices. These include graphics chips manufactured by NVIDIA®, which offers an NVIDIA® SHIELD development platform that runs Android Kit-Kat, and supports TV output via either HDMI or Miracast. It is further envisioned that other manufacturers will offer embedded solutions that will support both Android TV and Miracast.

In a non-limiting embodiment described below, the native graphics content thrown between the hybrid Miracast native graphics thrower and catcher comprise Android graphics commands and content. To better understand how this may be implemented on various Android platforms, a primer on Android graphics rendering is now provided.

### Android Graphics Rendering

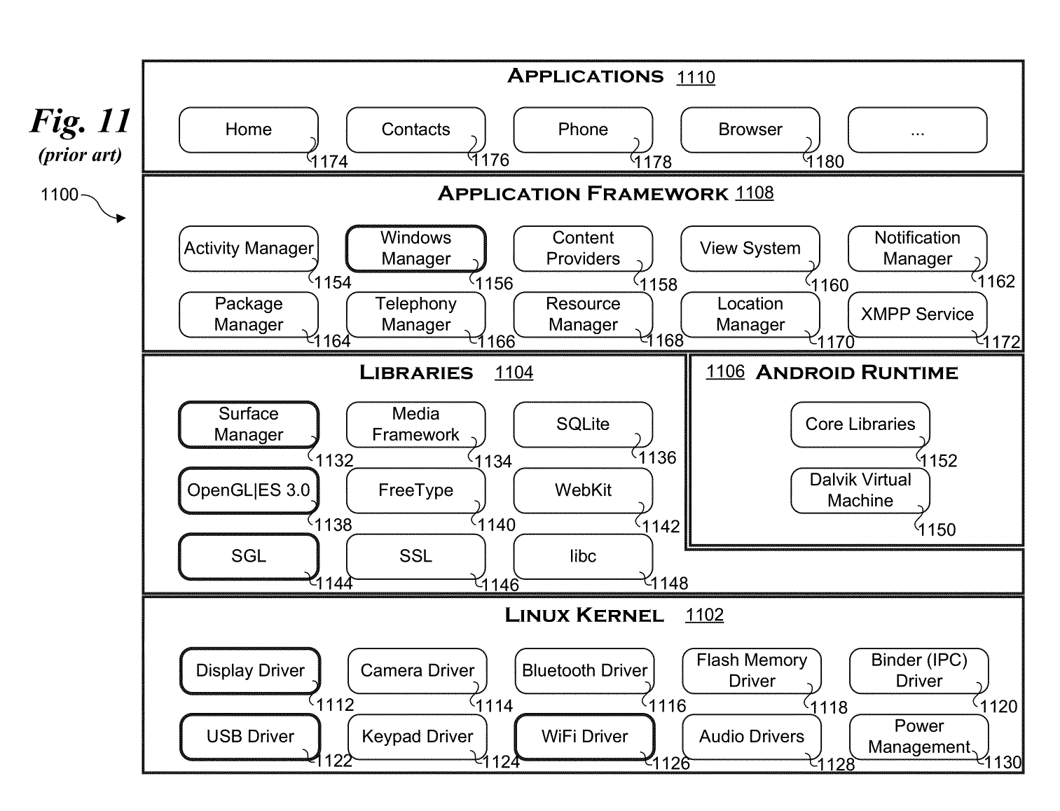

FIG. 11 shows a diagram illustrating the Android software architecture 1100. The Android software architecture includes Linux Kernel 1102, Libraries 1104, Android Runtime 1106, Application Framework 1108, and Applications 1110.

Linux Kernel 1102 occupies the lowest layer in the Android software stack, and provides a level of abstraction between the Android device hardware and the upper layers of the Android software stack. While some of Linux Kernel 1102 shares code with Linux kernel components for desktops and servers, there are some components that are specifically implemented by Google for Android. The current version of Android, Android 4.4 (aka “KitKat”) is based on Linux kernel 3.4 or newer (noting the actual kernel version depends on the particular Android device and chipset). The illustrated Linux Kernel 1102 components include a display driver 1112, a camera driver 1114, a Bluetooth driver 1116, a flash memory driver 1118, a binder driver 1120, a USB driver 1122, a keypad driver 1124, a Wi-Fi driver 1126, an audio drivers 1128, and power management 1130.

On top of Linux Kernel 1102 is Libraries 1104, which comprises middleware, libraries and APIs written in C/C++, and applications 1110 running on Application Framework 1108. Libraries 1104 are compiled and preinstalled by an Android device vendor for a particular hardware abstraction, such as a specific CPU. The libraries include surface manager 1132, media framework 1134, SQLite database engine 1136, OpenGL ES (embedded system) 1138, FreeType front library 1140, WebKit 1142, Skia Graphics Library (SGL) 1144, SSL (Secure Socket Layer) library 1146, and the libc library 1148. Surface manager 1130, also referred to as “SurfaceFlinger,” is a graphics compositing manager that composites graphics content for surfaces comprising off-screen bitmaps that are combined with other surfaces to create the graphics content displayed on an Android device, as discussed in further detail below. Media framework 1134 includes libraries and Codecs used for various multi-media applications, such as playing and recording videos, and support many formats such as AAC, H.264 AVC, H.263, MP3, and MPEG-4. SQLite database enjoy uses for storing and accessing data, and supports various SQL database function.

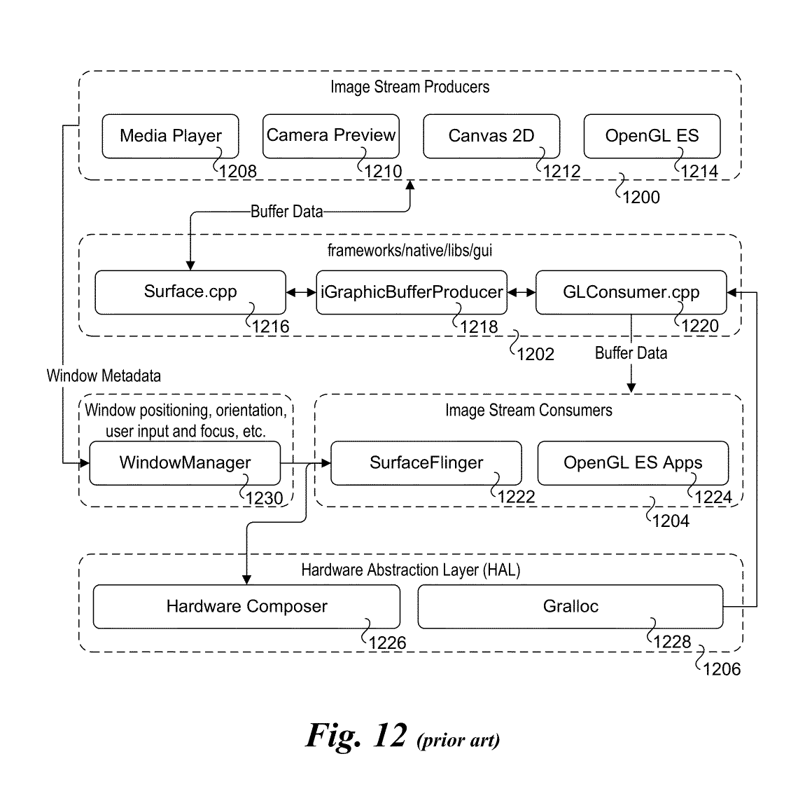

The Android software architecture employs multiple components for rendering graphics including OpenGL ES 1138, SGL 1144, FreeType font library 1140 and WebKit 1142. Further details of Android graphics rendering are discussed below with reference to FIG. 12.

Android runtime 1106 employs the Dalvik Virtual Machine (VM) 1150 and core libraries 1152. Android applications are written in Java (noting Android 4.4 also supports applications written in C/C++). Conventional Java programming employs a Java Virtual Machine (JVM) to execute Java bytecode that is generated by a Java compiler used to compile Java applications. Unlike JVMs, which are stack machines, the Dalvik VM uses a register-based architecture that requires fewer, typically more complex virtual machine instructions. Dalvik programs are written in Java using Android APIs, compiled to Java bytecode, and converted to Dalvik instructions as necessary. Core libraries 1152 support similar Java functions included in Java SE (Standard Edition), but are specifically tailored to support Android.

Application Framework 1108 includes high-level building blocks used for implementing Android Applications 1110. These building blocks include an activity manager 1154, a Windows manager 1156, content providers 1158, a view system 1160, a notifications manager 1162, a package manager 1164, a telephony manager 1166, a resource manager 1168, a location manager 1170, and an XMPP (Extensible Messaging and Presence Protocol) service 1172.

Applications 1110 include various application that run on an Android platform, as well as widgets, as depicted by a home application 1174, a contacts application 1176, a phone application 1178, and a browser 1180. The applications may be tailored for the particular type of Android platform, such as a tablet without mobile radio support would not have a phone application and may have additional applications designed for the larger size of a tablet's screen (as compared with a typical Android smartphone screen size).

The Android software architecture offers a variety of graphics rendering APIs for 2D and 3D content that interact with manufacturer implementations of graphics drivers. However, application developers draw graphics content to the display screen in two ways: with Canvas or OpenGL.

FIG. 12 illustrates selected Android graphics components. These components are grouped as image stream producers 1200, frameworks/native/libs/gui modules 1202, image stream consumers 1204, and a hardware abstraction layer (HAL) 1206. An image stream producer can be anything that produces graphic buffers for consumption. Examples include a media player 1208, camera preview application 1210, Canvas 2D 1212, and OpenGL ES 1214. The frameworks/native/libs/gui modules 1202 are C++ modules and include Surface.cpp 1216, iGraphicBufferProducer 1218, and GLConsumer.cpp 1220. The image stream consumers 1204 include SurfaceFlinger 1222 and OpenGL ES applications 1224. HAL 1206 includes a hardware composer 1226 and a Graphics memory allocator (Gralloc) 1228. The graphics components depicted in FIG. 12 also includes a WindowsManager 1230

The most common consumer of image streams is SurfaceFlinger 1222, the system service that consumes the currently visible surfaces and composites them onto the display using information provided by Window Manager 1224. SurfaceFlinger 1222 is the only service that can modify the content of the display. SurfaceFlinger 1222 uses OpenGL and Hardware Composer to compose a group of surfaces. Other OpenGL ES apps 1224 can consume image streams as well, such as the camera app consuming a camera preview 1210 image stream.

WindowManager 1230 is the Android system service that controls a window, which is a container for views. A window is always backed by a surface. This service oversees lifecycles, input and focus events, screen orientation, transitions, animations, position, transforms, z-order, and many other aspects of a window. WindowManager 1230 sends all of the window metadata to SurfaceFlinger 1222 so SurfaceFlinger can use that data to composite surfaces on the display.

Hardware composer 1226 is the hardware abstraction for the display subsystem. SurfaceFlinger 1222 can delegate certain composition work to Hardware Composer 1226 to offload work from OpenGL and the GPU. SurfaceFlinger 1222 acts as just another OpenGL ES client. So when SurfaceFlinger is actively compositing one buffer or two into a third, for instance, it is using OpenGL ES. This makes compositing lower power than having the GPU conduct all computation. Hardware Composer 1226 conducts the other half of the work. This HAL component is the central point for all Android graphics rendering. Hardware Composer 1226 supports various events, including VSYNC and hotplug for plug-and-play HDMI support.

android.graphics.Canvas is a 2D graphics API, and is the most popular graphics API among developers. Canvas operations draw the stock and custom android.view.Views in Android. In Android, hardware acceleration for Canvas APIs is accomplished with a drawing library called OpenGLRenderer that translates Canvas operations to OpenGL operations so they can execute on the GPU.

Beginning in Android 4.0, hardware-accelerated Canvas is enabled by default. Consequently, a hardware GPU that supports OpenGL ES 2.0 (or later) is mandatory for Android 4.0 and later devices. Android 4.4 requires OpenGL ES 3.0 hardware support.

In addition to Canvas, the other main way that developers render graphics is by using OpenGL ES to directly render to a surface. Android provides OpenGL ES interfaces in the android.opengl package that developers can use to call into their GL implementations with the SDK (Software Development Kit) or with native APIs provided in the Android NDK (Android Native Development Kit).

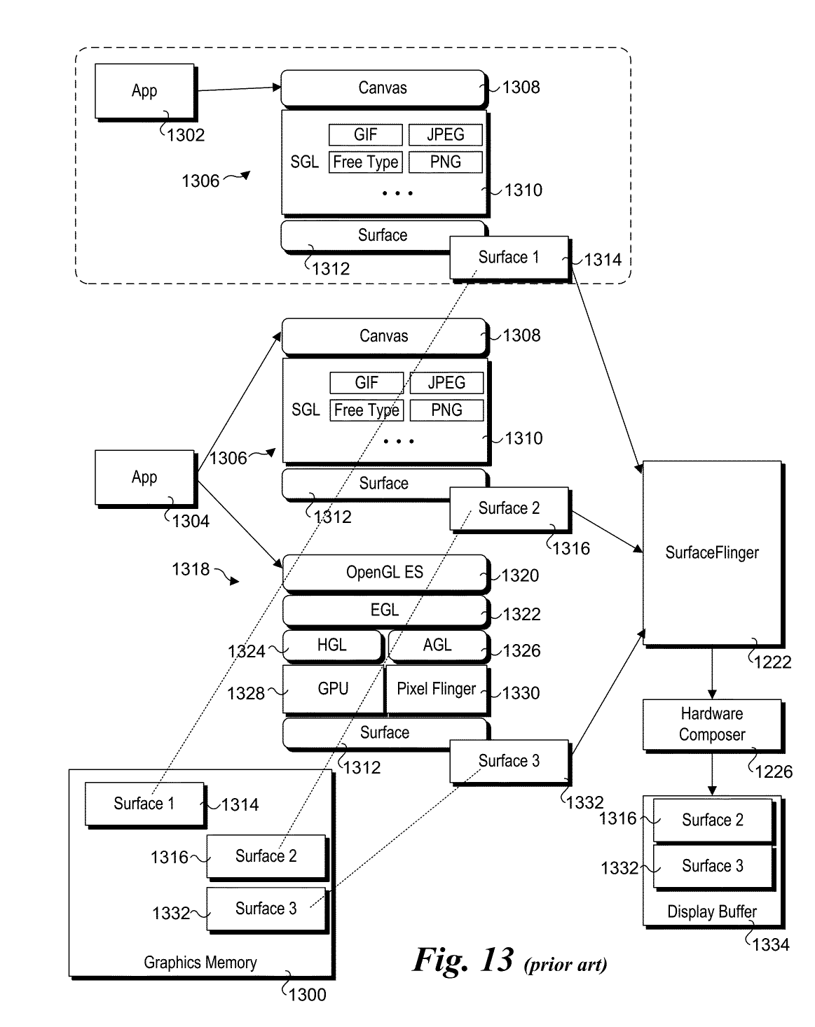

FIG. 13 graphically illustrates concepts relating to surfaces and the composition of the surfaces by SurfaceFlinger 1222 and the hardware composer 1228 to create the graphical content that is displayed on an Android device. As mentioned above, application developers are provided with two means for creating graphical content: Canvas and OpenGL. Each employ an API comprising a set of graphic commands for creating graphical content. That graphical content is “rendered” to a surface, which comprises a bitmap stored in graphics memory 1300.

FIG. 13 shows graphic content being generated by two applications 1302 and 1304. Application 1302 is a photo-viewing application, and uses a Canvas graphics stack 1306. This includes a Canvas API 1308, SGL 1310, the Skia 2D graphics software library, and the Android surface class 1312. Canvas API 1306 enables users to “draw” graphics content onto virtual views (referred to as surfaces) stored as bitmaps in graphics memory 1300 via Canvas drawing commands. Skia supports rendering 2D vector graphics and image content, such as GIFs, JPEGs, and PNGs. Skia also supports Androids FreeType text rendering subsystem, as well as supporting various graphic enhancements and effects, such as antialiasing, transparency, filters, shaders, etc. Surface class 1310 includes various software components for facilitating interaction with Android surfaces. Application 1302 renders graphics content onto a surface 1314.

Application 1304 is a gaming application that uses Canvas for its user interface and uses OpenGL for its game content. It employs an instance of Canvas graphics stack 1306 to render user interface graphics content onto a surface 1316. The OpenGL drawing commands are processed by an OpenGL graphics stack 1318, which includes an OpenGL ES API 1320, an embedded systems graphics library (EGL) 1322, a hardware OpenGL ES graphics library (HGL) 1324, an Android software OpenGL ES graphics library (AGL) 1326, a graphics processing unit (GPU) 1328, a PixelFlinger 1330, and Surface class 1310. The OpenGL drawing content is rendered onto a surface 1332.

The content of surfaces 1314, 1316, and 1332 are selectively combined using SurfaceFlinger 1222 and hardware composer 1226. In this example, application 1304 has the current focus, and thus bitmaps corresponding to surfaces 1316 and 1332 are copied into a display buffer 1334.

SurfaceFlinger's role is to accept buffers of data from multiple sources, composite them, and send them to the display. Under earlier versions of Android, this was done with software blitting to a hardware framebuffer (e.g. /dev/graphics/fb0), but that is no longer how this is done.

When an application comes to the foreground, the WindowManager service asks SurfaceFlinger for a drawing surface. SurfaceFlinger creates a “layer”—the primary component of which is a BufferQueue—for which SurfaceFlinger acts as the consumer. A Binder object for the producer side is passed through the WindowManager to the app, which can then start sending frames directly to SurfaceFlinger.

For most applications, there will be three layers on screen at any time: the “status bar” at the top of the screen, the “navigation bar” at the bottom or side, and the application's user interface and/or display content. Some applications will have more or less, e.g. the default home application has a separate layer for the wallpaper, while a full-screen game might hide the status bar. Each layer can be updated independently. The status and navigation bars are rendered by a system process, while the application layers are rendered by the application, with no coordination between the two.

Device displays refresh at a certain rate, typically 60 frames per second (fps) on smartphones and tablets. If the display contents are updated mid-refresh, “tearing” will be visible; so it's important to update the contents only between cycles. The system receives a signal from the display when it's safe to update the contents. This is referred to as the VSYNC signal.

The refresh rate may vary over time, e.g. some mobile devices will range from 58 to 62 fps depending on current conditions. For an HDMI-attached television, this could theoretically dip to 24 or 48 Hz to match a video. Because the screen can be updated only once per refresh cycle, submitting buffers for display at 200 fps would be a waste of effort as most of the frames would never be seen. Instead of taking action whenever an app submits a buffer, SurfaceFlinger wakes up when the display is ready for something new.

When the VSYNC signal arrives, SurfaceFlinger walks through its list of layers looking for new buffers. If it finds a new one, it acquires it; if not, it continues to use the previously-acquired buffer. SurfaceFlinger always wants to have something to display, so it will hang on to one buffer. If no buffers have ever been submitted on a layer, the layer is ignored.

Once SurfaceFlinger has collected all of the buffers for visible layers, it asks the Hardware Composer how composition should be performed. Hardware Composer 1222 was first introduced in Android 3.0 and has evolved steadily over the years. Its primary purpose is to determine the most efficient way to composite buffers with the available hardware. As a HAL component, its implementation is device-specific and usually implemented by the display hardware OEM.

The value of this approach is easy to recognize when you consider “overlay planes.” The purpose of overlay planes is to composite multiple buffers together, but in the display hardware rather than the GPU. For example, suppose you have a typical Android phone in portrait orientation, with the status bar on top and navigation bar at the bottom, and app content everywhere else. The contents for each layer are in separate buffers (i.e., on separate surfaces). You could handle composition by rendering the app content into a scratch buffer, then rendering the status bar over it, then rendering the navigation bar on top of that, and finally passing the scratch buffer to the display hardware. Or, you could pass all three buffers to the display hardware, and tell it to read data from different buffers for different parts of the screen. The latter approach can be significantly more efficient.

As one might expect, the capabilities of different display processors vary significantly. The number of overlays, whether layers can be rotated or blended, and restrictions on positioning and overlap can be difficult to express through an API. So, the Hardware Composer 1226 works as follows.

First, SurfaceFlinger 1222 provides Hardware Composer 1226 with a full list of layers, and asks, “how do you want to handle this?” Hardware Composer 1226 responds by marking each layer as “overlay” or “OpenGL ES (GLES) composition.” SurfaceFlinger 1222 takes care of any GLES composition, passing the output buffer to Hardware Composer 1226, and lets Hardware Composer 1226 handle the rest.

An exemplary hybrid Miracast and Android graphics thrower-catcher architecture is shown in FIG. 7a including a hybrid Android thrower device 700a that streams Miracast content and throws Android graphics commands and content to a hybrid Android catcher device 702a via a Wi-Fi Direct link 704. Various aspects of the hybrid Miracast and Android graphics thrower-catcher architecture of FIG. 7a are similar to those shown in FIG. 7 discussed above, including various components sharing the same reference numbers in both FIGS. 7 and 7a. Accordingly, the following will focus on implementation details that are particular to implementing an Android graphics thrower and catcher.

As discussed above, Android applications 1110 use canvas drawing commands and OpenGL drawing commands to generate graphics content that is displayed by an Android application. The canvas and OpenGL commands are implemented through Android graphic APIs 716, which initially split the command along the hardware rendering path for OpenGL commands and the software rendering path for canvas commands. Selected canvas commands are converted from Skia to OpenGL-equivalent commands via a Skia-to-OpenGL block 718, and those OpenGL commands are forwarded via the hardware rendering path.

Android graphics rendering subsystems 606a and 606Ra include a software rendering block 612a that employs a Skia runtime library 1144 to render Skia commands as associated content (e.g., image content) via the software rendering path. Further components include bitmap buffers 616a, SurfaceFlinger 1222, a GPU 614, and a hardware composer 1226.

FIG. 7a further depicts an Android graphics thrower 708a and an Android graphics catcher 710a. These components are similar to native graphics thrower 708 and native graphics catcher 710, except they are configured to throw Android graphic commands and associated content, including OpenGL commands, and Canvas and/or Skia commands and associated content.

For illustrative purposes, the Wi-Fi Direct links shown in the Figures herein are peer-to-peer (P2P) links. However, it is also possible to have Wi-Fi Direct links that are facilitated through use of a Wi-Fi access point. In either case, the WFD source and sink will establish a Wi-Fi Direct link that may be used for transferring Miracast H.264 streaming content, as well as applicable control information.

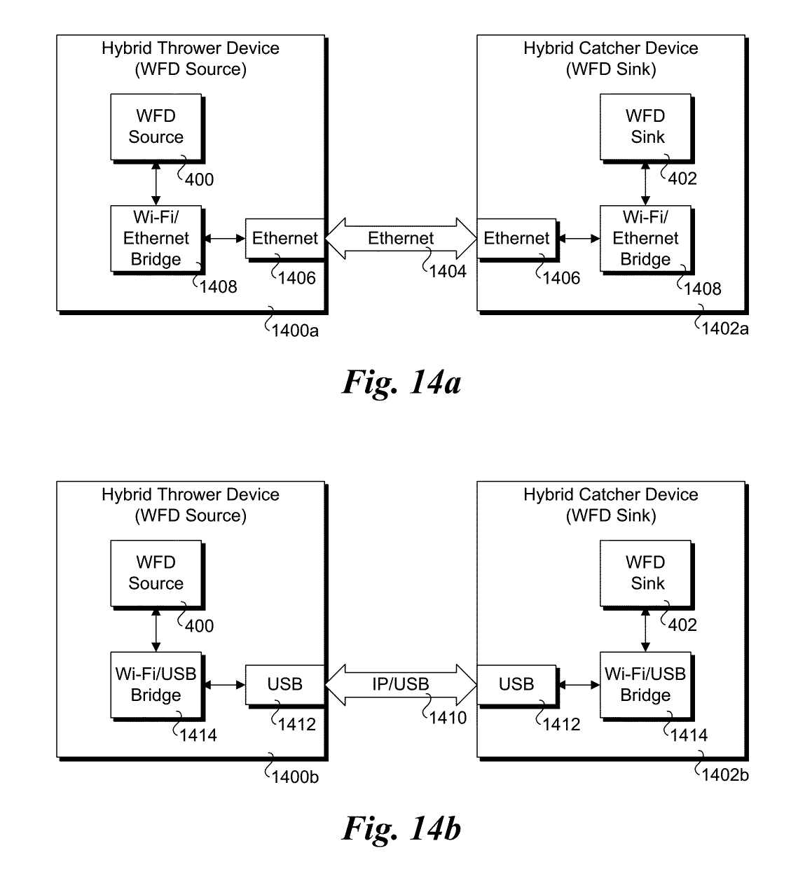

In addition to implementation of Wi-Fi Direct links over wireless interfaces, embodiments may be implemented using wired interfaces, wherein a Wi-Fi connection and its associated components are emulated. For example, FIG. 14a shows a hybrid thrower device 1400a linked in communication with a hybrid catcher device 1402a via an Ethernet link 1404. Hybrid thrower device 1400a includes an Ethernet interface 1406 coupled to a Wi-Fi/Ethernet bridge 1408, which in turn is coupled to a WFD source block 400. Similarly, hybrid catcher device 1402a includes an Ethernet interface 1406 coupled to a Wi-Fi/Ethernet bridge 1408, which in turn is coupled to a WFD sink block 402.

Wi-Fi, which is specified by the Wi-Fi Alliance™, is based on the Wireless Local Area Network (WLAN) protocol defined by the IEEE 802.11 family of standardized specifications. The MAC layer defined by 802.11 and the Ethernet MAC layer defined by the IEEE 802.3 Ethernet standards are similar, and it is common to process Wi-Fi traffic at Layer 3 and above in networking software stacks as if it were Ethernet traffic. Wi-Fi/Ethernet bridge 1408 functions as a bridge between the wired Ethernet interface 1400a and the signals the Wi-Fi MAC direct link layer 420 shown in FIG. 4 and discussed above. As with a Wi-Fi Direct link, a pseudo Wi-Fi Direct link implemented over an Ethernet physical link may either comprise an Ethernet P2P link, or it may employ an Ethernet switch or router (not shown).

As another options, FIG. 14b shows a hybrid thrower device 1400b linked in communication with a hybrid catcher device 1402b via a USB link 1410. Hybrid thrower device 1400b includes a USB interface 1412 coupled to a Wi-Fi/USB bridge 1414, which in turn is coupled to a WFD source block 400. Similarly, hybrid catcher device 1402b includes an USB interface 1412 coupled to a Wi-Fi/USB bridge 1414, which in turn is coupled to a WFD sink block 402.

As with Ethernet, data is transmitted over a USB link as a serial stream of data using a packetized protocol. However, the USB physical interface is different than an Ethernet PHY, and the packets used by USB are different than the Ethernet frame and packet scheme implemented by the Ethernet MAC layer. Accordingly, Wi-Fi/USB bridge 1414 is a bit more complex than Wi-Fi/Ethernet bridge 1408, since it has to bridge the dissimilarities between the IEEE 802.11 and USB protocols. As further illustrated in FIG. 14b, in one embodiment an IP packet scheme is implemented over USB link 1410.

In addition to supporting switching between Miracast and native graphics throwing modes, the principles and teachings herein may be implemented for generally with any screencasting technique for remotely displaying screen content. The operations and logic are similar to those discussed in the embodiments herein that employ Miracast, but rather than employing Miracast these embodiments implement another screencasting mechanism, including both existing and future screencasting techniques.

By way of example, FIG. 9a shows a flowchart 900a illustrating operations and logic for supporting mode switching between a generalized screencasting mode and a throwing Native Graphic throwing mode, accordingly to one embodiment. These operations and logic are similar to those discussed above with reference to flowchart 900 of FIG. 9, except a screencasting mode is used in place of Miracast. In addition, this more generalized approach may be implemented over both wireless and wireless links, with or without using a Wi-Fi Direct (or emulated Wi-Fi Direct) connection.

First, in a block 902a, the system source and sink are configured for the screencasting mode. This would be accomplished in a manner similar to setting up a Miracast link, wherein a screencasting source and screencasting sink would discover one another and connect over a remote display link (either wireless or wired). In a block 904 and a decision block 906, a determination is made to whether native graphics throwing is supported in a manner similar to like-numbered blocks in FIG. 9. If the answer to decision block 906 is NO, then the system will operate as a screencasting source and sink.

If native graphics throwing is supported, the source and sink devices are configured to initialize and switch to the native graphics throwing mode in blocks 910, 912a, and 914, wherein the screencasting stream is PAUSEd in block 912a in a manner analogous to PAUSEing the Miracast stream in block 912 of FIG. 9.

While operating in native graphics mode, the screencasting source detects a user starting screencasting-suitable content (event 916a), which causes the system to switch to the screencasting mode using an applicable mode-switch message, as depicted in a block 918a. In a block 920a, the source pauses throwing native graphics traffic, and restarts the screencasting flow in response to a PLAY or similar command from the sink.

As depicted by an event 922a and a block 924a at some point while in the screencasting mode, the screencasting source detects the user has switched to native-graphics suitable content, and switches the sink back to the native graphics throwing mode via native graphics throwing mode switch message. A similar mode switch may also occur without user input, such as if the end of playing the screencasting content is detected. Generally, native graphics-suitable content is any content that is both capable of being thrown using native graphics commands and content, and throwing of such content would result in a performance improvement over screencasting techniques.

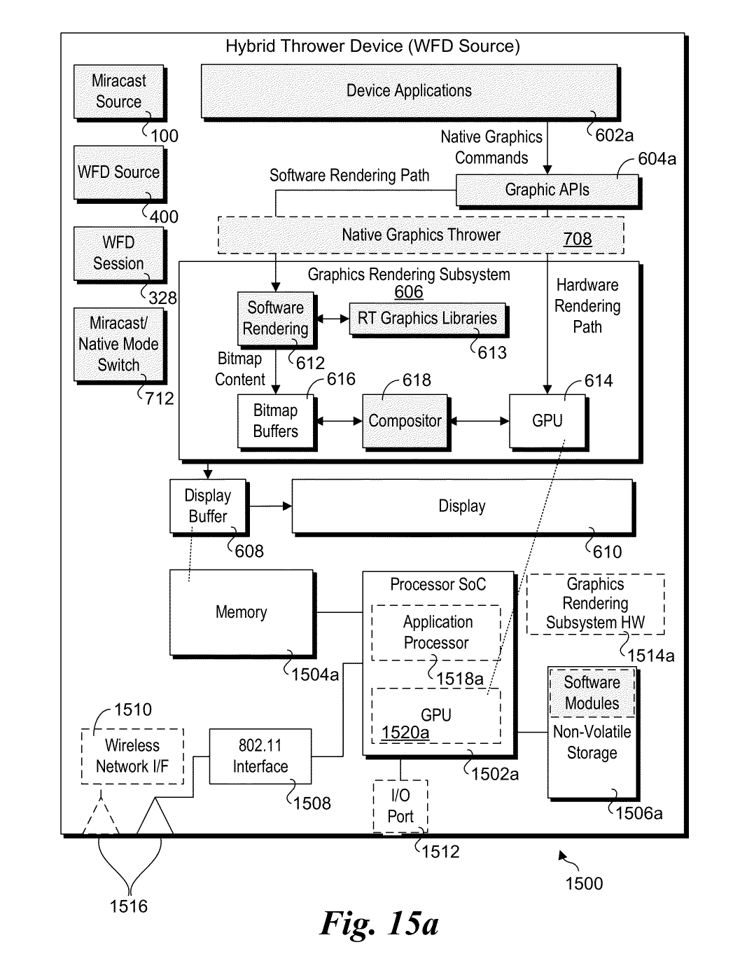

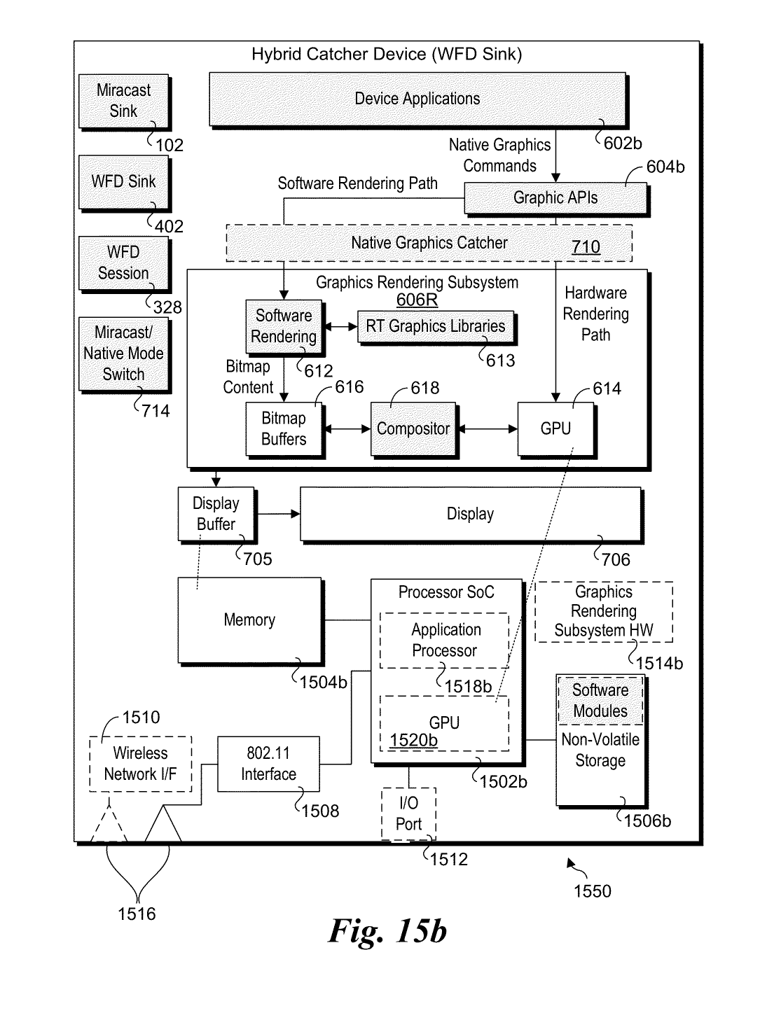

FIG. 15a illustrates a generalize hardware and software architecture for a hybrid thrower device 1500. Generally, the hardware components illustrated in FIG. 15a may be present in various types of devices implemented as a hybrid Miracast and native graphics thrower, wherein an actual device may have more or less hardware components. Such hardware components include a processor SoC 1502a to which memory 1504a, a non-volatile storage device 1506a, and an 802.11 interface 1508 are operatively coupled. The illustrated hardware components further include an optional second wireless network interface 1510, an Input/Output (I/O) port 1512, and a graphics rendering subsystem hardware (HW) block 1514a that is illustrative of a graphics rendering subsystem hardware that is not implemented on processor SoC 1502a. Each of 802.11 interface 1508 and wireless network interface 1510 are coupled to antenna(s) 1516.

Without limitation, processor SoC 1502a may comprise one or more processors offered for sale by INTEL® Corporation, NVIDIA®, ARM®, Qualcomm®, Advanced Micro Devices (AMD®), SAMSUNG® or APPLE®. As depicted in FIG. 15a, processor SoC 1502a includes an application processor 1518a section and a GPU 1520a. As is well-known, processor SoC's have various interfaces and features that are not illustrated in Processor SoC 1502a for simplicity, including various interfaces to external components, such as memory interfaces and I/O interfaces. In addition, a processor SoC may include one or more integrated wireless interfaces rather than employ separate components. As discussed above, a GPU may also be implemented as a separate component in addition to being integrated on a processor SoC, and may include its on-die memory as well as access other memory, including system memory.

Non-volatile storage device 1506a is used to store various software modules depicted in FIG. 15a in light gray, as well as other software components that are not shown for simplicity, such as operating system components. Generally, non-volatile storage device 1506a is representative of any kind of device that can electronically store instructions and data in a non-volatile manner, including but not limited to solid-state memory devices (e.g., Flash memory), magnetic storage devices, and optical storage devices, using any existing or future technology.

Wireless network interface 1510 is representative of one or more optional wireless interfaces that support a corresponding wireless communication standard. For example, wireless network interface 1510 may be configured to support “short range communication” using corresponding hardware and protocols for wirelessly sending/receiving data signals between devices that are relatively close to one another. Short range communication includes, without limitation, communication between devices using a BLUETOOTH® network, a personal area network (PAN), near field communication, ZigBee networks, an INTEL® Wireless Display (WiDi) connection, an INTEL® WiGig (wireless with gigabit capability) connection, millimeter wave communication, ultra-high frequency (UHF) communication, combinations thereof, and the like. Short range communication may therefore be understood as enabling direct communication between devices, without the need for intervening hardware/systems such as routers, cell towers, internet service providers, and the like. In one embodiment, a Wi-Fi Direct link may be implemented over one or more of these short range communication standards using applicable bridging components, as another option to using an 802.11 link. Wireless network interface 1510 may also be configured to support longer range communication, such as a mobile radio network interface (e.g., a 3G or 4G mobile network interface).

FIG. 15b illustrates a generalize hardware and software architecture for a hybrid catcher device 1550. Generally, the hardware components illustrated in FIG. 15b may be present in various types of devices implemented as a hybrid Miracast and native graphics catcher, wherein an actual device may have more or less hardware components. For illustrative purposes, the hardware components and configurations in FIGS. 15a and 15b are similar, but with separate suffixes ‘a’ and ‘b’ to indicate the components in hybrid thrower and catcher devices may perform similar functions, yet be implemented using different components.

To support screenscasting more generally, various components illustrated in FIGS. 15a and 15b that are specific to Miracast and WFD (as applicable, such as if the link employed is not a WFD link) would be replaced with corresponding components supporting the screencasting protocol. For example, in the case of screencasting using Apple's Airplay, suitable components for implementing an Airplay source and sink would be provided by the hybrid thrower and hybrid catcher devices.

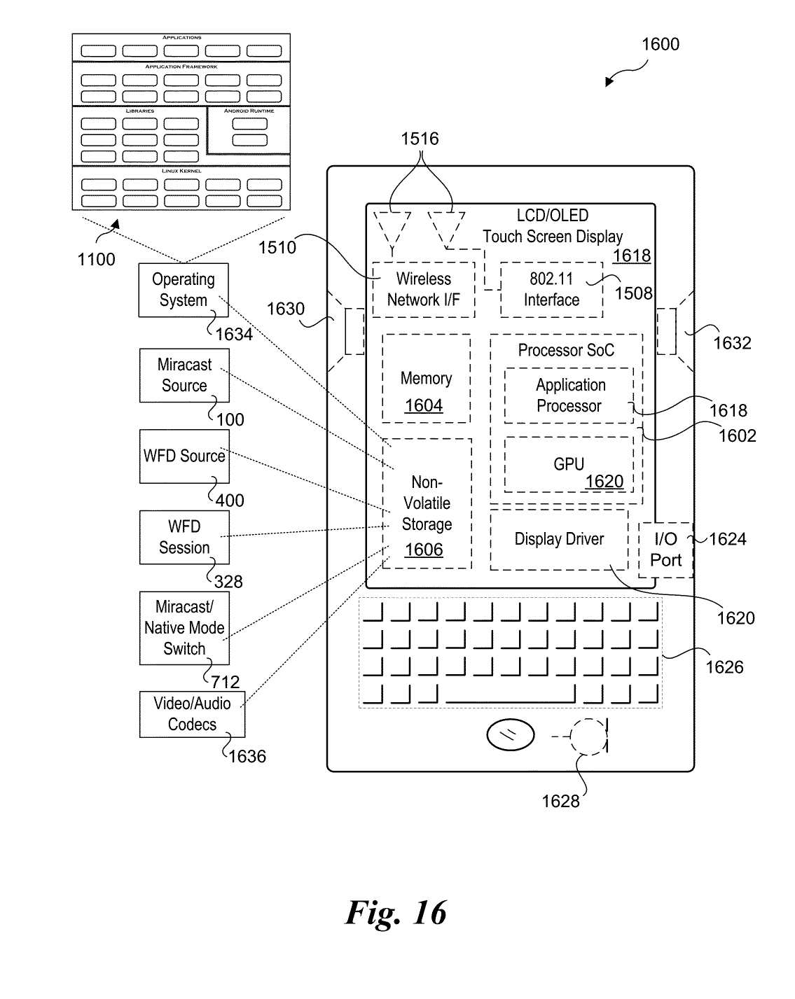

FIG. 16 shows a mobile device 1600 that includes additional software to support hybrid Miracast and native graphics thrower functionality in accordance with aspects of one or more of the embodiments described herein. Mobile device 1000 includes a processor SoC 1602 including an application processor 1618 and a GPU 1620. Processor SoC 1602 is operatively coupled to each of memory 1604, non-volatile storage 1606, an IEEE 802.11 wireless interface 1508, and a wireless network interface 1510, each of the latter two of which is coupled to a respective antenna 1516. Mobile device 1600 also includes a display screen 1618 comprising a liquid crystal display (LCD) screen, or other type of display screen such as an organic light emitting diode (OLED) display. Display screen 1618 may be configured as a touch screen though use of capacitive, resistive, or another type of touch screen technology. Mobile device 1600 further includes a display driver 1620, an I/O port 1624, a virtual or physical keyboard 1626, a microphone 1628, and a pair of speakers 1630 and 1632.

During operation, software instructions and modules comprising an operating system 1634, and software modules for implementing a Miracast source 100, a WFD source 400, WFD session 328, and Miracast/native mode switch 712 are loaded from non-volatile storage 1606 into memory 1604 for execution on an applicable processing element on processor SoC 1602. For example, these software components and modules, as well as other software instructions are stored in non-volatile storage 1606, which may comprises any type of non-volatile storage device, such as Flash memory. In one embodiment, logic for implementing one or more video codecs may be embedded in GPU 1620 or otherwise comprise video and audio codec instructions 1636 that are executed by application processor 1618 and/or GPU 1620. In addition to software instructions, a portion of the instructions for facilitating various operations and functions herein may comprise firmware instructions that are stored in non-volatile storage 1606 or another non-volatile storage device (not shown).

In addition, mobile device 1600 is generally representative of both wired and wireless devices that are configured to implement the functionality of one or more of the hybrid Miracast and native graphics thrower and hybrid Miracast and native graphics catcher embodiments described and illustrated herein. For example, rather than one or more wireless interfaces, Mobile device may have a wired or optical network interface, or implement an IP over USB link using a micro-USB interface.

Various components illustrated in FIG. 16 may also be used to implement various types of hybrid Miracast and native graphics catcher devices, such as set-top boxes, Blu-ray players, and smart HDTVs and UHDTVs. In the case of a set-top box or Blu-ray player, the hybrid Miracast and native graphics catcher device will generally include an HDMI interface and be configured to generate applicable HDMI signals to drive a display device connected via a wired or wireless HDMI link, such as an HDTV, UHDTV or computer monitor. Since smart HDTVs and UHDTVs have built-in displays, they can directly playback Miracast and thrown native graphics content thrown from a hybrid Miracast and native graphics thrower device.

In one embodiment, mobile device 1600 employs an Android operating system 1100, such as Android 4.4 or 5.0. Similarly, in some embodiments a hybrid Miracast and native graphics catcher may employ an Android operating system. In one embodiment, a hybrid Miracast and Android graphics catcher may be implemented by modifying an Android TV device to catch Android graphics content thrown by an Android graphics thrower. As discussed above, since the Android TV devices already implement Android 5.0 (or later versions anticipated to be used in the future), the software and hardware components used for rendering Android content already are present on the Android TV devices.

It is noted that foregoing embodiments implementing Android devices for hybrid Miracast native graphics throwers and catchers are merely exemplary, as devices employing other operating systems may be implemented in a similar manner. For example, in some embodiments MICROSOFT® WINDOWS™ and WINDOWS PHONE™ devices may be implemented, wherein the native graphics content comprises one or more of DIRECTX™, DIRECTX3D™, GDI (Graphics Device Interface), GDI+, and SILVERLIGHT™ graphics commands and content. Under an APPLE® iOS™ implementation, the thrown graphics content comprises Core Graphics (aka QUARTZ 2D™), Core Image, and Core Animation drawing commands and content. For these platforms, as well as other graphic platforms, the applicable rendering software and hardware components are implemented on the catcher, and the thrower is configured to trap and/or intercept the graphic commands and content and send these commands and content over a Wi-Fi Direct link to the catcher in a similar manner to that shown in FIGS. 7 and 7a.

Further aspects of the subject matter described herein are set out in the following numbered clauses:

1. A method comprising:

establishing a link between a source device and a sink device;

configuring the source device as a screencasting source and the sink device as a screencasting sink, and further configuring the screencasting source and screencasting sink to operate in a screencasting mode under which screencasting content is streamed from the screencasting source on the source device to the screencasting sink on the sink device over the link;

configuring the source device and the sink device to operate in a native graphics throwing mode, wherein the source device throws at least one of native graphics commands and native graphics content to the sink device over the link, and the native graphics commands and native graphics content that is thrown is rendered on the sink device;

detecting that screencasting-suitable content has been selected to be played on the source device or is currently displayed on the source device; and, in response thereto,

automatically switching to the screencasting mode; and

while in the screencasting mode, playing the screencasting-suitable content by streaming screencast content derived from the screencasting-suitable content from the source to the sink and playing back the screencast content on the sink device.

2. The method of clause 1, further comprising:

detecting that content suitable for native graphics throwing is being displayed on the source device; and in response thereto,

automatically switching back to the native graphics throwing mode.

3. The method of clause 1 or 2, wherein the native graphics commands include OpenGL commands.

4. The method of any of the proceeding clauses, wherein the source device comprises an Android device running an Android operating system and configured to operate as a screencasting source and throw Android graphics commands and content to the sink device.

5. The method of any of the proceeding clauses, wherein the sink device comprises an Android device running an Android operating system, configured to operate as a screencasting sink and configured to catch Android graphics commands and content thrown from the source device and render corresponding Android graphics content on the display.

6. The method of any of the proceeding clauses, wherein the source device and sink device respectively comprise a Miracast source and a Miracast sink.

7. The method of any of the proceeding clauses, wherein the link comprises a wireless peer-to-peer link.

8. The method of any of the proceeding clauses, wherein the link comprises an Internet Procotol (IP) link implemented over a Universal Serial Bus (USB) connection coupling the source device in communication with the sink device.

9. A method comprising:

establishing a Wi-Fi Direct (WFD) link between a WFD source device and a WFD sink device;

configuring the WFD source device as a Miracast source and the WFD sink device as a Miracast sink, and further configuring the Miracast source and Miracast sink to operate in a Miracast mode under which Miracast content is streamed from the Miracast source on the WFD source device to the Miracast sink on the WFD sink device over the WFD link;

configuring the WFD source device and the WFD sink device to operate in a native graphics throwing mode, wherein the WFD source device throws at least one of native graphics commands and native graphics content to the WFD sink device over the WFD link;

detecting that Miracast content has been selected to be played on the WFD source device; and, in response there to,

automatically switching to the Miracast mode; and

while in Miracast mode, playing the Miracast content by streaming Miracast content from the Miracast source to the Miracast sink and playing back the Miracast content on the WFD sink device.

10. The method of clause 9, further comprising:

detecting the Miracast content has completed playing; and in response thereto,

automatically switching back to the native graphics throwing mode.

11. The method of clause 9 or 10, further comprising:

setting up the WFD source device and WFD sink device to operate as a Miracast source and Miracast sink in Miracast mode in accordance with a Miracast standard;

exchanging RTSP (Real-time Streaming Protocol) M3 GET PARAMETER request and RTSP M3 GET PARAMETER response messages between the WFD source device and the WFD sink device to discover the WFD sink device supports the native graphics throwing mode;

sending an RTSP M4 SET PARAMETER request message from the WFD source device to the WFD sink device to switch to the native graphics throwing mode; and

returning an RTSP M4 SET PARAMETER response message with a value of ‘OK’ from the WFD sink device to the WFD source device.

12. The method of clause 11, wherein setting up the WFD source device and WFD sink device to operate as a Miracast source and Miracast sink in Miracast mode in accordance with the Miracast standard includes setting up an RTSP connection between the WFD source device and the WFD sink device, the RTSP connection configured to transport a Miracast RTP (Real-time Transport Protocol) stream, the method further comprising:

issuing a PAUSE command to pause the Miracast RTP stream; and

periodically exchanging Miracast Keepalive messages between the WFD source device and WFD sink device to keep the RTSP connection alive.

13. The method of clause 11 or 12, wherein setting up the WFD source device and WFD sink device to operate as a Miracast source and Miracast sink in Miracast mode in accordance with the Miracast standard includes setting up an RTSP connection between the WFD source device and the WFD sink device, the RTSP connection configured to transport a Miracast RTP (Real-time Transport Protocol) stream, the method further comprising:

operating the WFD source device and WFD sink device in the native graphics throwing mode;

detecting, via a Miracast source stack, a user of the WFD source device starting Miracast-suitable content;

sending an RTSP M4 SET PARAMETER request message from the WFD source device to the WFD sink device to switch to the Miracast mode; and

returning an RTSP M4 SET PARAMETER response message with a value of ‘OK’ from the WFD sink device to the WFD source device.

operating the WFD source device and the WFD sink device in the Miracast mode to stream the Miracast-content derived from the Miracast-suitable content from the WFD source device to the WFD sink device over the RTSP connection.

14. The method of clause 13, further comprising:

pausing throwing native graphics commands from the WFD sink device to the WFD source device; and

restarting the Miracast RTP stream at the WFD source device in response to receiving an RTSP PLAY message from the WFD sink device.

15. The method of any of clauses 11-14, further comprising:

setting up a TCP (Transmission Control Protocol) link over the WFD link;

exchanging, via the RTSP M3 GET PARAMETER request and RTSP M3 GET PARAMETER response messages, TCP port numbers to be used by the WFD source device and WFD sink device to throw native graphics payload over the TCP link.

16. The method of any of clauses 11-15, wherein the native graphics commands include OpenGL commands.

17. The method of any of clauses 11-16, wherein the WFD source device comprises an Android device running an Android operating system and configured to operate as a Miracast source and configured to throw Android graphics commands and content to the WFD sink device.

18. The method of any of clauses 11-17, wherein the WFD sink device comprises an Android device running an Android operating system, configured to operate as a Miracast sink and configured to catch Android graphics commands and content thrown from the WFD source device and render corresponding Android graphics content on the display.

19. The method of clause 18, wherein the Android device comprises an Android TV device.

20. The method of any of clauses 11-19, wherein the WFD link is implemented over a wired connection between the WFD source device and the WFD sink device.

21. An apparatus comprising:

a processor;

memory, coupled to the processor; and

a non-volatile storage device, operatively coupled to the processor, having a plurality of software modules stored therein, including,

a Wi-Fi Direct (WFD) source module, including software instructions for implementing a WFD source stack when executed by the processor;

a WFD session module, including software instructions for establishing a WFD session using the apparatus as a WFD source when executed by the processor;

a Miracast source module, including software instructions for implementing a Miracast source when executed by the processor;

a native graphics thrower module, including software instructions for implementing a native graphics thrower when executed by the processor; and

a Miracast/native graphics mode switch module, including software instructions for switching between a Miracast mode and a native graphics throwing mode when executed by the processor.

22. The apparatus of clause 21, wherein the software instructions in the plurality of software modules are configured to, upon execution by the processor, enable the apparatus to:

establish a WFD link between the apparatus and a second apparatus, wherein the apparatus is configured to operate as a WFD source and the second apparatus comprises a WFD sink device;

configure the apparatus to operate as a Miracast source and set up an Real-time Streaming Protocol (RTSP) link over the WFD link;

configure the apparatus to operate in a Miracast mode under which Miracast content is streamed as a Real-time Transport Protocol (RTP) stream over the RTSP link from the apparatus to a Miracast sink operating on the second apparatus;

configure the apparatus to operate in a native graphics throwing mode, wherein the apparatus devices throws at least one of native graphics commands and native graphics content over the WFD link to a native graphics catcher operating on the second apparatus;

detect that Miracast content has been selected to be played by a user of the apparatus; and, in response there to,

automatically switching to the Miracast mode; and

while in Miracast mode, playing the Miracast content by streaming Miracast content to the Miracast sink operating on the second apparatus.

23. The apparatus of clause 22, wherein the software instructions in the plurality of software modules are configured to, upon execution by the processor, further enable the apparatus to:

detect the Miracast content has completed playing; and in response thereto,

automatically switch that apparatus back to the native graphics throwing mode.

24. The apparatus of clause 22 or 23, wherein the software instructions in the plurality of software modules are configured to, upon execution by the processor, further enable the apparatus to:

send one or more RTSP M3 GET PARAMETER request messages to the second apparatus and receive one or more RTSP M3 GET PARAMETER response messages from the second apparatus to discover the second apparatus supports the native graphics throwing mode;

send an RTSP M4 SET PARAMETER request message to the second apparatus to switch to the native graphics throwing mode;

receive an RTSP M4 SET PARAMETER response message with a value of ‘OK’ from the second apparatus; and

throw native graphics commands to the second apparatus while operating in the native graphics throwing mode.

25. The apparatus of clause 24, wherein the software instructions in the plurality of software modules are configured to, upon execution by the processor, further enable the apparatus to:

issue a PAUSE command to pause the Miracast RTP stream; and

periodically send Miracast Keepalive messages to the second apparatus to keep the RTSP connection alive.

26. The apparatus of clause 24 or 25, wherein the software instructions in the plurality of software modules are configured to, upon execution by the processor, further enable the apparatus to:

operate the apparatus in the native graphics throwing mode;

detect a user of the apparatus starting a movie;

send an RTSP M4 SET PARAMETER request message to the second apparatus to switch to the Miracast mode; and

receive an RTSP M4 SET PARAMETER response message with a value of ‘OK’ from the second apparatus; and

operate the apparatus in the Miracast mode to stream the movie as an RTP stream over the RTSP connection.

27. The apparatus of any of clauses 21-26, wherein the apparatus comprises in Android device that is configured to throw Android graphics commands including OpenGL commands.

28. An apparatus comprising:

a processor;

memory, coupled to the processor; and

a non-volatile storage device, operatively coupled to the processor, having a plurality of software modules stored therein, including, a Wi-Fi Direct (WFD) sink module, including software instructions for implementing a WFD sink stack when executed by the processor;

a WFD session module, including software instructions for establishing a WFD session using the apparatus as a WFD sink when executed by the processor;

a Miracast sink module, including software instructions for implementing a Miracast sink when executed by the processor;

a native graphics catcher module, including software instructions for implementing a native graphics catcher when executed by the processor; and

a Miracast/native graphics mode switch module, including software instructions for switching between a Miracast mode and a native graphics catching mode when executed by the processor.

29. The apparatus of clause 28, wherein the software instructions in the plurality of software modules are configured to, upon execution by the processor, enable the apparatus to:
establish a WFD link between the apparatus and a second apparatus, wherein the apparatus is configured to operate as a WFD sink and the second apparatus comprises a WFD source device;

configure the apparatus to operate as a Miracast sink and set up an Real-time Streaming Protocol (RTSP) link over the WFD link;

configure the apparatus to operate in a Miracast mode under which Miracast content is streamed as a Real-time Transport Protocol (RTP) stream over the RTSP link from a Miracast source operating on the second apparatus to the Miracast sink operating on the apparatus;

configure the apparatus to operate as a native graphics catcher in a native graphics throwing mode, wherein the second apparatus throws at least one of native graphics commands and native graphics content over the WFD link to a native graphics catcher operating on the apparatus;

in response to a Miracast mode switch message received from the second apparatus, switch operation of the apparatus to the Miracast mode; and

while in the Miracast mode, play back Miracast content streamed from the Miracast source operating on the second apparatus.

30. The apparatus of clause 29, wherein the software instructions in the plurality of software modules are configured to, upon execution by the processor, further enable the apparatus to:

in response to a native graphics throwing mode switch message received from the second apparatus, switch operation of the apparatus to the native graphics throwing mode.

31. The apparatus of clause 29 or 30, wherein the software instructions in the plurality of software modules are configured to, upon execution by the processor, further enable the apparatus to:

receive one or more RTSP M3 GET PARAMETER request messages from the second apparatus and return one or more RTSP M3 GET PARAMETER response messages to the second apparatus to verify the apparatus supports the native graphics throwing mode;

receive an RTSP M4 SET PARAMETER request message from the second apparatus to switch to the native graphics throwing mode;

return an RTSP M4 SET PARAMETER response message with a value of ‘OK’ to the second apparatus; and

catch and render native graphics commands thrown from the second apparatus while operating in the native graphics throwing mode.

32. The apparatus of any of clauses 28-31, wherein the apparatus comprises in Android device that is configured to catch and render Android graphics commands including OpenGL commands.

33. The apparatus of clause 32, wherein the apparatus comprises an Android TV apparatus.

34. A tangible non-transient medium, having instructions comprising a plurality of software modules stored therein configured to be executed on a processor of a device, including:

a source module, including software instructions for implementing a WFD source stack when executed by the processor;

a WFD session module, including software instructions for establishing a WFD session using the device as a WFD source when executed by the processor;

a Miracast source module, including software instructions for implementing a Miracast source when executed by the processor;

a native graphics thrower module, including software instructions for implementing a native graphics thrower when executed by the processor; and

a Miracast/native graphics mode switch module, including software instructions for switching between a Miracast mode and a native graphics throwing mode when executed by the processor.

35. The tangible non-transient machine readable medium of clause 34, wherein the software instructions in the plurality of software modules are configured to, upon execution by the processor, enable the device to:

establish a WFD link between the device and a second device, wherein the device is configured to operate as a WFD source and the second device comprises a WFD sink device;

configure the device to operate as a Miracast source and set up an Real-time Streaming Protocol (RTSP) link over the WFD link;

configure the device to operate in a Miracast mode under which Miracast content is streamed as a Real-time Transport Protocol (RTP) stream over the RTSP link from the device to a Miracast sink operating on the second device;

configure the device to operate in a native graphics throwing mode, wherein the device devices throws at least one of native graphics commands and native graphics content over the WFD link to a native graphics catcher operating on the second device;

detect that Miracast content has been selected to be played by a user of the device;

and, in response there to, automatically switching to the Miracast mode; and

while in Miracast mode, playing the Miracast content by streaming Miracast content to the Miracast sink operating on the second device.

36. The tangible non-transient machine readable medium of clause 35, wherein the software instructions in the plurality of software modules are configured to, upon execution by the processor, further enable the device to:

detect the Miracast content has completed playing; and in response thereto,

automatically switch that device back to the native graphics throwing mode.

37. The tangible non-transient machine readable medium of any of clauses 34-36, wherein the software instructions in the plurality of software modules are configured to, upon execution by the processor, further enable the device to:

send one or more RTSP M3 GET PARAMETER request messages to the second device and receive one or more RTSP M3 GET PARAMETER response messages from the second device to discover the second device supports the native graphics throwing mode;

send an RTSP M4 SET PARAMETER request message to the second device to switch to the native graphics throwing mode;

receive an RTSP M4 SET PARAMETER response message with a value of ‘OK’ from the second device; and

throw native graphics commands to the second device while operating in the native graphics throwing mode.

38. The tangible non-transient machine readable medium of any of clauses 34-37, wherein the software instructions in the plurality of software modules are configured to, upon execution by the processor, further enable the device to:

issue a PAUSE command to pause the Miracast RTP stream; and

periodically send Miracast Keepalive messages to the second device to keep the RTSP connection alive.

39. The tangible non-transient machine readable medium of any of clauses 34-38, wherein the software instructions in the plurality of software modules are configured to, upon execution by the processor, further enable the device to:

operate the device in the native graphics throwing mode;

detect a user of the device starting a movie;

send an RTSP M4 SET PARAMETER request message to the second device to switch to the Miracast mode; and

receive an RTSP M4 SET PARAMETER response message with a value of ‘OK’ from the second device; and

operate the device in the Miracast mode to stream the movie as an RTP stream over the RTSP connection.

40. The tangible non-transient machine readable medium of any of clauses 34-39, wherein the device comprises in Android device that is configured to throw Android graphics commands including OpenGL commands.

41. A tangible non-transient medium, having instructions comprising a plurality of software modules stored therein configured to be executed on a processor of a device, including:

a Wi-Fi Direct (WFD) sink module, including software instructions for implementing a WFD sink stack when executed by the processor;

a WFD session module, including software instructions for establishing a WFD session using the device as a WFD sink when executed by the processor;

a Miracast sink module, including software instructions for implementing a Miracast sink when executed by the processor;

a native graphics catcher module, including software instructions for implementing a native graphics catcher when executed by the processor; and

a Miracast/native graphics mode switch module, including software instructions for switching between a Miracast mode and a native graphics catching mode when executed by the processor.

42. The tangible non-transient machine readable medium of clause 41, wherein the software instructions in the plurality of software modules are configured to, upon execution by the processor, enable the device to:

establish a WFD link between the device and a second device, wherein the device is configured to operate as a WFD sink and the second device comprises a WFD source device;

configure the device to operate as a Miracast sink and set up an Real-time Streaming Protocol (RTSP) link over the WFD link;

configure the device to operate in a Miracast mode under which Miracast content is streamed as a Real-time Transport Protocol (RTP) stream over the RTSP link from a Miracast source operating on the second device to the Miracast sink operating on the device;

configure the device to operate as a native graphics catcher in a native graphics throwing mode, wherein the second device throws at least one of native graphics commands and native graphics content over the WFD link to a native graphics catcher operating on the device;

in response to a Miracast mode switch message received from the second device, switch operation of the device to the Miracast mode; and

while in the Miracast mode, play back Miracast content streamed from the Miracast source operating on the second device.

43. The tangible non-transient machine readable medium of clause 41 or 42, wherein the software instructions in the plurality of software modules are configured to, upon execution by the processor, further enable the device to:

in response to a native graphics throwing mode switch message received from the second device, switch operation of the device to the native graphics throwing mode.

44. The tangible non-transient machine readable medium of any of clauses 41-43, wherein the software instructions in the plurality of software modules are configured to, upon execution by the processor, further enable the device to:

receive one or more RTSP M3 GET PARAMETER request messages from the second device and return one or more RTSP M3 GET PARAMETER response messages to the second device to verify the device supports the native graphics throwing mode;

receive an RTSP M4 SET PARAMETER request message from the second device to switch to the native graphics throwing mode;

return an RTSP M4 SET PARAMETER response message with a value of ‘OK’ to the second device; and

catch and render native graphics commands thrown from the second device while operating in the native graphics throwing mode.

45. The tangible non-transient machine readable medium of any of clauses 41-44, wherein the device comprises in Android device that is configured to catch and render Android graphics commands including OpenGL commands.

46. The tangible non-transient machine readable medium of any of clauses 41-45, wherein the device comprises an Android TV device.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

As discussed above, various aspects of the embodiments herein may be facilitated by corresponding software and/or firmware components and applications, such as software and/or firmware executed by an embedded processor or the like. Thus, embodiments of this invention may be used as or to support a software program, software modules, firmware, and/or distributed software executed upon some form of processor, processing core or embedded logic a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method comprising:
establishing a link between a source device and a sink device;
configuring the source device as a screencasting source and the sink device as a screencasting sink, and further configuring the screencasting source and screencasting sink to operate in a screencasting mode under which screencasting content is streamed from the screencasting source on the source device to the screencasting sink on the sink device over the link;
configuring the source device and the sink device to operate in a native graphics throwing mode, wherein the source device throws at least one of native graphics commands and native graphics content to the sink device over the link, and the native graphics commands and native graphics content that is thrown is rendered on the sink device;
detecting that screencasting-suitable content has been selected to be played on the source device or is currently displayed on the source device; and, in response thereto,
automatically switching to the screencasting mode; and
while in the screencasting mode, playing the screencasting-suitable content by streaming screencast content derived from the screencasting-suitable content from the source to the sink and playing back the screencast content on the sink device.

2. The method of claim 1, further comprising:
detecting that content suitable for native graphics throwing is being displayed on the source device; and in response thereto,
automatically switching back to the native graphics throwing mode.

3. The method of claim 1, wherein the native graphics commands include OpenGL commands.

4. The method of claim 1, wherein the source device comprises an Android device running an Android operating system and configured to operate as a screencasting source and throw Android graphics commands and content to the sink device.

5. The method of claim 1, wherein the sink device comprises an Android device running an Android operating system, configured to operate as a screencasting sink and configured to catch Android graphics commands and content thrown from the source device and render corresponding Android graphics content on the display.

6. The method of claim 1, wherein the source device and sink device respectively comprise a Miracast source and a Miracast sink.

7. The method of claim 1, wherein the link comprises a wireless peer-to-peer link.

8. The method of claim 1, wherein the link comprises an Internet Procotol (IP) link implemented over a Universal Serial Bus (USB) connection coupling the source device in communication with the sink device.

9. A method comprising:
establishing a Wi-Fi Direct (WFD) link between a WFD source device and a WFD sink device;
configuring the WFD source device as a Miracast source and the WFD sink device as a Miracast sink, and further configuring the Miracast source and Miracast sink to operate in a Miracast mode under which Miracast content is streamed from the Miracast source on the WFD source device to the Miracast sink on the WFD sink device over the WFD link;
configuring the WFD source device and the WFD sink device to operate in a native graphics throwing mode, wherein the WFD source device throws at least one of native graphics commands and native graphics content to the WFD sink device over the WFD link;
detecting that Miracast content has been selected to be played on the WFD source device; and, in response there to,
automatically switching to the Miracast mode; and
while in Miracast mode, playing the Miracast content by streaming Miracast content from the Miracast source to the Miracast sink and playing back the Miracast content on the WFD sink device.

10. The method of claim 9, further comprising:
detecting the Miracast content has completed playing; and in response thereto, automatically switching back to the native graphics throwing mode.

11. The method of claim 9, further comprising:
setting up the WFD source device and WFD sink device to operate as a Miracast source and Miracast sink in Miracast mode in accordance with a Miracast standard;
exchanging RTSP (Real-time Streaming Protocol) M3 GET PARAMETER request and RTSP M3 GET PARAMETER response messages between the WFD source device and the WFD sink device to discover the WFD sink device supports the native graphics throwing mode;
sending an RTSP M4 SET PARAMETER request message from the WFD source device to the WFD sink device to switch to the native graphics throwing mode; and
returning an RTSP M4 SET PARAMETER response message with a value of ‘OK’ from the WFD sink device to the WFD source device.

12. The method of claim 11, wherein setting up the WFD source device and WFD sink device to operate as a Miracast source and Miracast sink in Miracast mode in accordance with the Miracast standard includes setting up an RTSP connection between the WFD source device and the WFD sink device, the RTSP connection configured to transport a Miracast RTP (Real-time Transport Protocol) stream, the method further comprising:
issuing a PAUSE command to pause the Miracast RTP stream; and
periodically exchanging Miracast Keepalive messages between the WFD source device and WFD sink device to keep the RTSP connection alive.

13. The method of claim 11, wherein setting up the WFD source device and WFD sink device to operate as a Miracast source and Miracast sink in Miracast mode in accordance with the Miracast standard includes setting up an RTSP connection between the WFD source device and the WFD sink device, the RTSP connection configured to transport a Miracast RTP (Real-time Transport Protocol) stream, the method further comprising:
operating the WFD source device and WFD sink device in the native graphics throwing mode;
detecting, via a Miracast source state, a user of the WFD source device starting Miracast-suitable content;
sending an RTSP M4 SET PARAMETER request message from the WFD source device to the WFD sink device to switch to the Miracast mode; and
returning an RTSP M4 SET PARAMETER response message with a value of ‘OK’ from the WFD sink device to the WFD source device.
operating the WFD source device and the WFD sink device in the Miracast mode to stream the Miracast-content derived from the Miracast-suitable content from the WFD source device to the WFD sink device over the RTSP connection.

14. The method of claim 13, further comprising:
pausing throwing native graphics commands from the WFD sink device to the WFD source device; and
restarting the Miracast RTP stream at the WFD source device in response to receiving an RTSP PLAY message from the WFD sink device.

15. The method of claim 11, further comprising:
setting up a TCP (Transmission Control Protocol) link over the WFD link;
exchanging, via the RTSP M3 GET PARAMETER request and RTSP M3 GET PARAMETER response messages, TCP port numbers to be used by the WFD source device and WFD sink device to throw native graphics payload over the TCP link.

16. The method of claim 9, wherein the native graphics commands include OpenGL commands.

17. The method of claim 9, wherein the WFD source device comprises an Android device running an Android operating system and configured to operate as a Miracast source and configured to throw Android graphics commands and content to the WFD sink device.

18. The method of claim 9, wherein the WFD sink device comprises an Android device running an Android operating system, configured to operate as a Miracast sink and configured to catch Android graphics commands and content thrown from the WFD source device and render corresponding Android graphics content on the display.

19. The method of claim 18, wherein the Android device comprises an Android TV device.

20. The method of claim 9, wherein the WFD link is implemented over a wired connection between the WFD source device and the WFD sink device.

21. An apparatus comprising:
a processor;
memory, coupled to the processor; and
a non-volatile storage device, operatively coupled to the processor, having a plurality of software modules stored therein, including,
a Wi-Fi Direct (WFD) source module, including software instructions for implementing a WFD source stack when executed by the processor;
a WFD session module, including software instructions for establishing a WFD session using the apparatus as a WFD source when executed by the processor;
a Miracast source module, including software instructions for implementing a Miracast source when executed by the processor;
a native graphics thrower module, including software instructions for implementing a native graphics thrower when executed by the processor; and
a Miracast/native graphics mode switch module, including software instructions for switching between a Miracast mode and a native graphics throwing mode when executed by the processor.

22. The apparatus of claim 21, wherein the software instructions in the plurality of software modules are configured to, upon execution by the processor, enable the apparatus to:
establish a WFD link between the apparatus and a second apparatus, wherein the apparatus is configured to operate as a WFD source and the second apparatus comprises a WFD sink device;
configure the apparatus to operate as a Miracast source and set up an Real-time Streaming Protocol (RTSP) link over the WFD link;
configure the apparatus to operate in a Miracast mode under which Miracast content is streamed as a Real-time Transport Protocol (RTP) stream over the RTSP link from the apparatus to a Miracast sink operating on the second apparatus;
configure the apparatus to operate in a native graphics throwing mode, wherein the apparatus devices throws at least one of native graphics commands and native graphics content over the WFD link to a native graphics catcher operating on the second apparatus;
detect that Miracast content has been selected to be played by a user of the apparatus; and, in response there to,
automatically switching to the Miracast mode; and
while in Miracast mode, playing the Miracast content by streaming Miracast content to the Miracast sink operating on the second apparatus.

23. The apparatus of claim 22, wherein the software instructions in the plurality of software modules are configured to, upon execution by the processor, further enable the apparatus to:
detect the Miracast content has completed playing; and in response thereto, automatically switch that apparatus back to the native graphics throwing mode.

24. The apparatus of claim 22, wherein the software instructions in the plurality of software modules are configured to, upon execution by the processor, further enable the apparatus to:
send one or more RTSP M3 GET PARAMETER request messages to the second apparatus and receive one or more RTSP M3 GET PARAMETER response messages from the second apparatus to discover the second apparatus supports the native graphics throwing mode;
send an RTSP M4 SET PARAMETER request message to the second apparatus to switch to the native graphics throwing mode;
receive an RTSP M4 SET PARAMETER response message with a value of ‘OK’ from the second apparatus; and
throw native graphics commands to the second apparatus while operating in the native graphics throwing mode.

25. The apparatus of claim 24, wherein the software instructions in the plurality of software modules are configured to, upon execution by the processor, further enable the apparatus to:
issue a PAUSE command to pause the Miracast RTP stream; and
periodically send Miracast Keepalive messages to the second apparatus to keep the RTSP connection alive.

26. The apparatus of claim 24, wherein the software instructions in the plurality of software modules are configured to, upon execution by the processor, further enable the apparatus to:
operate the apparatus in the native graphics throwing mode;
detect a user of the apparatus starting a movie;
send an RTSP M4 SET PARAMETER request message to the second apparatus to switch to the Miracast mode; and
receive an RTSP M4 SET PARAMETER response message with a value of ‘OK’ from the second apparatus; and
operate the apparatus in the Miracast mode to stream the movie as an RTP stream over the RTSP connection.

27. The apparatus of claim 21, wherein the apparatus comprises in Android device that is configured to throw Android graphics commands including OpenGL commands.

28. An apparatus comprising:
a processor;
memory, coupled to the processor; and
a non-volatile storage device, operatively coupled to the processor, having a plurality of software modules stored therein, including,
a Wi-Fi Direct (WFD) sink module, including software instructions for implementing a WFD sink stack when executed by the processor;
a WFD session module, including software instructions for establishing a WFD session using the apparatus as a WFD sink when executed by the processor;
a Miracast sink module, including software instructions for implementing a Miracast sink when executed by the processor;
a native graphics catcher module, including software instructions for implementing a native graphics catcher when executed by the processor; and
a Miracast/native graphics mode switch module, including software instructions for switching between a Miracast mode and a native graphics catching mode when executed by the processor.

29. The apparatus of claim 28, wherein the software instructions in the plurality of software modules are configured to, upon execution by the processor, enable the apparatus to:
establish a WFD link between the apparatus and a second apparatus, wherein the apparatus is configured to operate as a WFD sink and the second apparatus comprises a WFD source device;
configure the apparatus to operate as a Miracast sink and set up an Real-time Streaming Protocol (RTSP) link over the WFD link;
configure the apparatus to operate in a Miracast mode under which Miracast content is streamed as a Real-time Transport Protocol (RTP) stream over the RTSP link from a Miracast source operating on the second apparatus to the Miracast sink operating on the apparatus;
configure the apparatus to operate as a native graphics catcher in a native graphics throwing mode, wherein the second apparatus throws at least one of native graphics commands and native graphics content over the WFD link to a native graphics catcher operating on the apparatus;
in response to a Miracast mode switch message received from the second apparatus, switch operation of the apparatus to the Miracast mode; and
while in the Miracast mode, play back Miracast content streamed from the Miracast source operating on the second apparatus.

30. The apparatus of claim 29, wherein the software instructions in the plurality of software modules are configured to, upon execution by the processor, further enable the apparatus to:
in response to a native graphics throwing mode switch message received from the second apparatus, switch operation of the apparatus to the native graphics throwing mode.

31. The apparatus of claim 29, wherein the software instructions in the plurality of software modules are configured to, upon execution by the processor, further enable the apparatus to:
receive one or more RTSP M3 GET PARAMETER request messages from the second apparatus and return one or more RTSP M3 GET PARAMETER response messages to the second apparatus to verify the apparatus supports the native graphics throwing mode;
receive an RTSP M4 SET PARAMETER request message from the second apparatus to switch to the native graphics throwing mode;
return an RTSP M4 SET PARAMETER response message with a value of ‘OK’ to the second apparatus; and
catch and render native graphics commands thrown from the second apparatus while operating in the native graphics throwing mode.

32. The apparatus of claim 28, wherein the apparatus comprises in Android device that is configured to catch and render Android graphics commands including OpenGL commands.

33. The apparatus of claim 32, wherein the apparatus comprises an Android TV apparatus.
